(19) United States
(12) Patent Application Publication
(10) Pub. No.: US 2006/0257441 A1
(43) Pub. Date: Nov. 16, 2006

(54) Natural essential oil sanitary insect pest repellent and its use

(75) Inventors: Koichiro Komai, Kyoto (JP); Satoko Hayase, Yamatotakada (JP); Osamu Hayase, Yamatotakada (JP); Masayasu Miwata, Uji (JP); Osamu Sakurai, Wakayama (JP); Osamu Kuroki, Osaka (JP); Masaaki Mizuguchi, Osaka (JP); Michiyo Ichihara, Joyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SUZUKI YUSHI INDUSTRIAL CO., LTD., Osaka-shi (JP); REFRE CO., LTD., Joyo-shi (JP); DAIHO PARFUMERY CO., LTD., Osaka-shi (JP); Satoko HAYASE, Yamatotakada-shi (JP)

(21) Appl. No.: 11/125,204

(22) Filed: May 10, 2005

(51) Int. Cl. A01N 25/00; A01N 65/00

(52) U.S. Cl. 424/405; 424/725

(57) ABSTRACT

[Object] This invention provides a dispersion containing an insect pest repellent active substance, and an adhesive or bond, ink, resin pellets, a resin product, and a sheet or a film which can exhibit a long term repellent active effect by the particles carrying the dispersion. [Means for achieving the object] The invention also concerns with a natural essential oil having a sanitary pest repellent activity; a dispersion containing, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction given by fractionating the remnant of the second fraction using a 1:1 mixture of ethyl acetate/chloroform as an elution solvent; a dispersion thereof containing a sedimentation inhibitor, particles carrying these dispersions, and a sanitary insect pest repellent active adhesive or bond, ink, resin pellets, resin particles, resin product, sheet or film, and device containing the same.

### FIELD OF THE INVENTION

The present invention relates to a natural essential oil having an activity of repelling sanitary insect pests, and more particularly to a sanitary insect pest repellent containing, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction given by fractionating the remnant of the second fraction using a 1:1 mixture of ethyl acetate/chloroform as an elution solvent; and the invention also concerns with organic high-molecular-weight particles or inorganic particles carrying said active component, organic high-molecular-weight particles or inorganic particles containing a sedimentation inhibitor, a dispersion thereof, an adhesive or bond having an activity of repelling sanitary insect pests, ink having an activity of repelling sanitary insect pests, sanitary insect pest repellent active resin pellets, a sanitary insect pest repellent active resin product, a sanitary insect pest repellent active sheet and/or film, and a device for spreading a sanitary insect pest repellent active composition.

### BACKGROUND ART

When a life space is kept in a specified range of a comfortable temperature all the year round, such circumstance promotes a multiplication of sanitary insect pests, typically stored grain insect pests such as cockroaches, mites, termites, rice weevils and Indian meal moth. These days, insect pests have been seen not only in household kitchens but also in storehouses for equipment and raw materials in food plants and in sale rooms for foods, etc. Insecticides conventionally used for controlling sanitary insect pests such as organic phosphorus-based, carbamate-based or pyrethroid-based compounds have a high insecticidal property and are inexpensive, so that they have been used for ages.

However, in view of toxicity of such insecticides, these insecticides require special attention in their use, for example, at a site where one may touch it or at a food plant. In such place, it is preferred to use repellents derived from safe natural substances for their high safety. Repellents are substances which do not allow a harmful organism to come near according to its nature or taxis, especially negative taxis when it commences its action.

Repellents are low in temporary or definite insecticidal effect compared with insecticides. Therefore, the repellent is required to continue the repellent action for achieving an insecticidal effect.

Vegetable essential oils such as those of pines, sun trees, camphors and the like are known as natural substances having a repellent activity against sanitary insect pests. The repellent active components contained in them include terpene, especially sesquiterpene. Repelling activities against cockroaches are reportedly exhibited by sesquiterpene such as elemol, β-eudesmol and β-vetivon (Japanese Unexamined Patent Publication No. Hei 8-81306). Effective cockroach repellents are natural essential oils including orange flower oil, geranium oil, thyme white oil, thyme red oil, nutmeg oil, patchouli oil, palmarosa oil, bitter orange oil, lemongrass oil, fragrant olive oil, sesame oil, cinnamon leaf oil, cinnamon burk, cassia, celery seed oil, tolu balsam oil, Peru balsam, etc. Ant repellents are natural essential oils including oakmoss, orange flower oil, sandalwood oil, spearmint oil, thyme white oil, patchouli oil, palmarosa oil, lemongrass oil, laurel oil, garlic oil, fragrant olive oil, coconut oil, cinnamon leaf oil, dill oil (inonde oil), thyme red oil, tolu balsam oil, birch oil, Peru balsam (Japanese Unexamined Patent Publication No. Hei 10-130114). Effective termite repellents are an extract of seeds of Xylopia aethiopica, amide cinnamate derivative isolated from the extract, and synthetic analogies thereof (Japanese Unexamined Patent Publication No. Hei 6-16609), fratoxin prepared from an extract of aoganpi (Wiskstroemiaretusa A. Gray), i.e., natural plant widely occurring along the coastline of Okinawa Prefecture, and novel fratoxin derivatives thereof (Japanese Unexamined Patent Publication No. Hei 7-48378), and an extract of seeds of Aframomum melegueta and ketone isolated from the extract and synthetic analogs (Japanese Unexamined Patent Publication No. Hei 9-194318), penyroyal oil and neem oil (Japanese Unexamined Patent Publication No. 2001-106609). These natural essential oils have been used as an aroma. Vaporization of the aroma can be made slower by addition of preservatives, gelation, subsumption with cyclodextrin or microencapsulation.

Conventional microcapsules are decomposed by heating. Thus a procedure involving heating was inevitably avoided and the capsules were to be broken by other means to release the aroma.

On the other hand, recent adhesive or bond technology has made a remarkable progress. Adhesives are used in various fields and are uniformly applied to papers, plastics films, foams, metallic foils, etc. Commercial products such as adhesive tapes and adhesive sheets/labels are now available.

During storage, sanitary insect pests may settle or dwell in medical articles, sanitary goods or packaged foods involving use of adhesives. Especially if the adhesive of a packaging label is loosely attached, a sanitary insect may make its way and may remain as a dead body after death, thereby extremely reducing the commercial value. Further, food packaging is now regarded as important in view of a remarkable development of precooked foods in food industry and a marked change of sale system.

### DISCLOSURE OF THE INVENTION

Problem to be Resolved by the Invention

The problem to be overcome by the invention is to keep sanitary insect pests from coming near.

Means for Overcoming the Problem

The present inventors have disclosed that copaiba oil containing caryophyllene has a high activity of repelling insect pests (Japanese Patent Application No. 167615/2000). Copaiba oil is not decomposed by heating, and can be processed by heating. The inventors developed slowly releasable inorganic porous particles having high capsule strength (Japanese Examined Patent Publication No. Sho 57-055454). In addition, the present inventors discovered the following. When copaiba oil is carried on slowly releasable inorganic porous particles and the particles remain in an adhesive or bond or ink, then a medical article, then a sanitary product or a packaged food having the adhesive or bond attached thereto can be protected from insect pests for a long time. Slowly releasable inorganic porous particles can be made into pellets. Even when resin pellets are commercially manufactured in the same manner as conventional pellets, the product can retain a sanitary insect pest repelling activity. When the slowly releasable inorganic porous particles are carried on a sheet or a film, the repellent activity can be given to the sheet or film. Based on these novel findings, a patent application was filed in the Japanese Patent Office (Patent Application No. 334843/2001). The inventors further pursued the research. It was discovered that a highly insect pest repellent active product can be produced from a natural essential oil repellent active substance which is at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction given by fractionating the remnant of the second fraction using a 1:1 mixture of ethyl acetate/chloroform as an elution solvent. Based on the above-described novel findings, the present invention was completed.

The first aspect of the invention is directed to a natural essential oil having a sanitary insect pest repellent activity which contains at least one of, as an active ingredient, copaiba oil, β-caryophyllene and a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent.

The second aspect of the invention is directed to a natural essential oil sanitary pest repellent has the foregoing active ingredient carried on slowly releasable organic high-molecular-weight particles. The third aspect of the invention is directed to a natural essential oil sanitary pest repellent which has the foregoing active ingredient carried on slowly releasable inorganic particles.

The fourth aspect of the invention is directed to a dispersion of each of these repellents. The fifth aspect of the invention is directed to an adhesive or bond, or ink having a repelling activity against sanitary insect pests. The sixth aspect of the invention is directed to an adhesive or bond product produced using the adhesive or bond, or to a printed matter produced using the ink.

The 7th aspect of the invention is directed to resin pellets having an activity of repelling sanitary insect pests, and to a resin product produced using the resin pellets as the raw material, the resin pellets containing, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent. The 8th aspect of the invention is directed to a sheet or a film having an activity of repelling sanitary insect pests and containing, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent.

The 9th aspect of the invention is directed to a device for spreading a repellent or a dispersion which contains, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent.

The foregoing fractions of copaiba oil to be used in the invention will be described below.

<Copaiba Oil>

The copaiba oil is an essential oil prepared by distillation of copaiba balsam which is a colorless flowable oleoresin collected from a tree trunk of Leguminosae termed Copaifera L. by opening a hole to the pith of the tree. The oil is a colorless or yellow liquid having an odor specific to copaiba balsam. Copaifera L. occurs in a hot-climate north area of South Africa or in Brazil, Venezuela, Guayana, Suriname and Columbia, especially in the basins of the Amazon and the Orinoco. The plant has a large trunk and a smooth bark, and is a big tree with numerous branches. Some trees stand 30 m high. The oleoresin from the tree stem of the plant is a physiological by-product accumulated in the tree trunk and in separated ducts abounding in cavities formed by decomposition of soft tissue cell wall. The by-product is spread or connected with each other, finally giving a large amount of accumulated copaiba balsam. The tree may be often broken with a big sound under the pressure. Natives use the product as an antibacterial agent.

The copaiba balsam is mainly composed of an essential oil and a resin. Although the composition and properties of copaiba balsam are not stable, caryophyllene, humulene, copaene and the like are known as sesquiterpene composing the copaiba oil.

The odor of copaiba balsam is faint, lightly woody and spicy (pepper-like) and is properly sustained and well matched with various spices. It can be used as a modifier for aromatic perfume. Its flavor is bitter and stimulating. It tastes so piercing as to cause vomiting. According to the regulations of FDA, copaiba oil shall contain 50 to 70% of β-caryophyllene (FDA No. 172-510).

<First Fraction>

The first fraction is produced by fractionating copaiba oil by silica gel column chromatography (replenishment silica gel: BW-127ZH) using hexane as an elution solvent. Specific examples include copaene (e.g., abounding in copanoba balsam essential oil produced in the Philippines), trans-α-bergamotene, (e.g. lemon essential oil produced in Italy/abounding in bergamot essential oil), β-elemene, β-caryophyllene, humulene, γ-muurolene, etc.

<Second Fraction>

The second fraction is produced by fractionating the remnant left after fractionating the first fraction by silica gel column chromatography (replenishment silica gel: BW-127ZH) using a 4:4:1 mixture of hexane/chloroform/ethyl acetate as an elution solvent. Specific examples are garmacrene-D and -B (abounding in bergamot essential oil/copaiba oil), Delta-Cadinene (e.g. abounding in cedarwood essential oil), cis-calamenene (e.g. abounding in calamus essential oil), farnesene, caryophyllene oxide, caryophyllene alcohol, and so on.

<Third Fraction>

The third fraction is produced by fractionating the remnant of the second fraction left after fractionating the second fraction using a 1:1 mixture of ethyl acetate/chloroform as an elution solvent. Specific examples are α-caryophylene alcohol (e.g. abounding in clove leaf essential oil), t-cadinol, torreyol, α-cadinol, and so on.

In the invention, the foregoing fractions can be used as dissolved in a proper solvent. Useful solvents are those capable of dissolving these fractions. Typical examples are hexane, acetone, ethyl acetate and chloroform.

Organic high-molecular-weight particles to be used in the invention include particles composed of organic polymers. Typical examples are organic gels which are not limited and can be any of substances which can achieve crosslinking. Especially substances can be used insofar as they can gel from a liquid state. More specifically, useful substances are those which is crosslinkable by any of covalent bonding, ionic bonding, intermolecular bond, etc. Examples include those which can gel by interlocking, namely can be any of substances insofar as the subsumed compound can be solidified by gelling or by film forming.

In crosslinking by covalent bonding, a gel may be formed using a monomer, a crosslinking agent, an initiator, etc. Useful monomers may be any of those to be used in conventional radial polymerization and are not limited. Examples of useful monomers are acrylamide, methacrylamide, N-vinylpyrrodone, N-vinylacetoamide, N-vinylformamide, acrylic acid, methacrylic acid, styrene, p-styrenesulfonic acid, vinylsulfonic acid, 2-methacryloyloxyethylsulfonic acid, 3-methacryloyloxy-2-hydroxypropylsulfonic acid, allylsulfonic acid, methacrylsulfonic acid and ammonium salts of these acids and alkali metal salts thereof, dimethylaminoethyl acrylate, dimethylaminoethyl methacrylate, and hydrochloric acid, nitric acid, dimethylsulfuric acid, diethylsulfuric acid, or quaternary ethyl chloride of 2-vinylpyridine, and 4-vinylpyridine 2-hydroxyethyl methacrylate, 2-hydroxyethyl acrylate, 2-acrylamide-2-methlypropanesulfonic acid and copolymers thereof. Examples of the crosslinking agents having 2 or more polymeric functional groups are ethylene glycol, propylene glycol, trimethylolpropane, glycerin, polyoxyethylene glycol, polyoxypropylene glycol, polyglycerin, N,N′-methylenebisacrylamide, N,N-methylene-bis-N-vinylacetoamide, N,N-butylene-bis-N vinylacetoamide, tolylene diisocyanate, hexamethylene diisocyanate, allylated starch, allylated cellulose, diallylphthalate, tetraallyloxyethane, pentaerythritol triallyl ether, trimethylolpropane triallyl ether, diethylene glycol diallyl ether, triallyltrimellitate, etc. Useful initiators are not limited. Initiators which are suited for gelation are selected. Suitable initiators are, for example, hydrogen peroxide, persulfate, such as potassium persulfate, sodium persulfate, ammonium persulfate, etc. Azo initiators such as 2,2′-azobis(2-amidinopropane)dihydrochloride, 2,2′-azobis(N,N′-dimethyleneisobutylamidine) dihydrochloride, 2,2′-azobis {2-methyl-N-[1,1-bis(hydroxymethyl)-2-hydroxyethyl]propionamide}, 2,2′-azobis[2-(2-imidazoline-2-yl)propane]-dihydrochloride, 4,4′-azobis(4-cyanovalerianic acid), 2,2′-azobisisobutyronitrile, 2,2′-azobis(2,4′-dimethylvaleronitrile), etc. Hydrogen peroxide or persulfate can be used as a redox-based initiator in combination with sulfite, L-ascorbic acid and like reductive substances and an amine salt.

In crosslinking by ionic bonding, e.g., a high-molecular-weight electrolyte having a cation or anion such as ammonium salt or carboxyl group is crosslinked by ionic bonding with a polyvalent ionic substance such as calcium to give a gel.

Crosslinking by intermolecular bonding is often done using natural polymer such as starch, galactmannan, nitrocelluose, methyl cellulose, hydroxypropylmethyl cellulose, pectic acid, alginic acid, agar, carageenan, protecoglycan, glycoprotein, gelatin, actin, tubulin, hemoglobin S, insulin, fibrin, ovalbumin, serum albumin, myosin, collagen, polypeptide, etc. Polyvinyl alcohol is illustrative of synthetic polymers.

Solvents for use in gelation are not limited but are those suitable for gelation, e.g., water, alcohol, acetone, tetrahydrofuran, dimethylformamide, diethyl ether, n-pentane, n-hexane, n-heptane, n-octane, cyclohexane, methylcyclohexane, benzene, toluene, xylene, etc.

A film is formed around the droplets by conventional micro-encapsulation, such as interfacial polymerization, in-situ polymerization, etc. Interfacial polymerization is carried out for micro-encapsulation by a method including the steps of adding a microcapsule film-forming raw material to a suspension of a repellent active component, and adding a water-soluble microcapsule film-forming raw material, if required, to water having dispersed the droplets of the suspension. Examples of the microcapsule film-forming raw material are polyvalent isocyanato (e.g. hexamethylene diisocyanato, trimethyl hexamethylene diisocyanato, isophorone diisocyanato, phenylene diisocyanato, toluene diisocyanato, xylylene diisocyanato, naphthalene diisocyanato, polymetylene polyphenyl diisocyanato, etc.), polyvalent carboxylic chloride (e.g., sebasic dichloride, adipic dichloride, azelaic dichloride, terephthalic dichloride, trimesic dichloride, etc.) Examples of the water-soluble film-forming raw material are polyhydric alcohol (e.g. ethylene glycol, butane diol, hexane diol, etc.), polyvalent amine (e.g., ethylene diamine, hexamethylene diamine, phenylene diamine, diethylene triamine, triethylene tetramine, piperazine, etc.) and the like. A film-forming reaction is conducted usually at 0 to 80° C., preferably 40 to 80° C., for about 0.5 to about 48 hours. A catalyst can be used to accelerate the reaction. In this way, a film of polyurethane, polyurea, polyamide, polyester, polysulfonate, polysulfoneamide or the like is formed.

In conducting the micro-encapsulating method by in-situ polymerization in the following manner, droplets of the suspension are dispersed in water and a water-soluble prepolymer, such as aminoplast, ureaformalin condensate, melamine formalin condensate or the like is added to the aqueous dispersion. The mixture is heated usually to 40 to 80° C. with stirring and is retained for about 0.5 to about 48 hours.

A slurry of microencapsulated repellent thus produced can be used as a repellent alone. However, usually a thickener, anti-freezing agent, anti-septic, gravity adjuster, and so on. are added to the repellent to provide an aqueous suspension. Examples of the thickener are xanthan gum, phamsan gum, locust bean gum, carrageenan, welan gum and like natural polysaccharides, sodium polyacrylate and like synthetic polymers, carboxymethyl cellulose, and the like, semi-synthetic polymers, aluminum magnesium silicate, smectites, bentonite, hectorite, dry silica and like mineral particles, alumina sol, and so on. Useful anti-freezing agents include propylene glycol. Useful anti-septics are, for example, p-hydroxybenzoic ester, salicylic acid derivatives, etc. Useful gravity adjusters are sodium sulfate and like water-soluble salts, urea and like water-soluble fertilizers. These can be used in the form of particles produced by spray dry method.

Base materials to be used for the gel of the invention are chiefly oligomers and monomers having unsaturated bonds curable by light energy.

Examples of the oligomers usable as the base materials for the gel are polyester acrylate, epoxy acrylate, urethane acrylate, alkyd resin acrylate, spiran resin acrylate, etc.

Useful monomers include, for example, monofunctional, bifunctional and polyfunctional monomers. Useful monofunctional monomers include, for example, 2-ethylhexyl acrylate, 2-hydroxypropyl acrylate, tetrahydrofurfuryl acrylate, 2-hydroxyethyl acrylate, phenoxyethyl acrylate, nonylphenoxyethyl acrylate, tetrahydrofurfuryloxyethyl acrylate, tetrahydrofurfuryloxyhexanolyde acrylate, ε-caprolactone adduct of 1,3-dioxane alcohol with acrylate, etc. Useful bifunctional monomers include hexanediol diacrylate, neopentyl glycol diacrylate, diethylene glycol diacrylate, tripropylene glycol diacrylate, polyethylene glycol diacrylate, hydroxypivalic acid neopentyl glycol diacrylate, neopentyl glycol adipate diacrylate, 1,6-hexanedioldiglycidyl ether diacrylate, and so on. Useful polyfunctional monomers include trimethylolpropane triacrylate, propionic acid dipentaerythritol triacrylate, propionic acid dipentaerythritol tetraacrylate, propionic acid dipentaerythritol pentaacrylate, dipentaerythritol hexaacrylate, ethylene oxide adduct of trimethylolpropane with triacrylate, ethylene oxide or propylene oxide adduct of trimethylolpropane with triacrylate, ε-caprolactone adduct of dipentaerythritol with hexaacrylate, etc.

The mixing ratio of the oligomer and the monomer is not limited. Generally when the oligomer is mixed in a larger amount, the mixture has a high viscosity in an uncured state, whereas when a more amount of the monomer is used, the mixture becomes too soft and becomes difficult to cure while the aroma is faster vaporized.

Therefore, the mixing ratio of the oligomer and the monomer should be adjusted in view of the fluidity and workability of uncured gel base material, the type and shape of the material for the container, releasable time of aroma and according to the kinds of the oligomer and the monomer. Generally it is proper that the oligomer/monomer mixing ratio is approximately from 5:95 to 70:30, more preferably from 10:90 to 50:50.

The gel base materials chiefly composed of the oligomer and the monomer may contain a photopolymerization initiator or a photo sensitizer to polymerize and gel the materials by light energy.

Examples of the photopolymerization initiator or the photo sensitizer are benzyldimethylketal, benzoinisobutyl ether, benzoinisopropyl ether, benzoinethyl ether, benzoinmethyl ether, 1-phenyl-1,2-propanedione-2-(o-ethoxycarbonyl)oxime, 2,2-dimethoxy-2-phenylacetophenone, hydroxycyclohexylphenyl ketone, diethoxyacetophenone, 2-hydroxy-2-methyl-1-phenylpropane-1-one, benzophenone, p-chlorobenzophenone, chlorothioxanthone, isopropylthioxanthone, 2-methylthioxanthone, triethanolamine, diethylethanolamine, etc.

The amount of the phtopolymerization initiator or the photo sensitizer is properly about 3 wt % based on the gel base material.

Slowly releasable repellent active particles can be produced by allowing the organic high-molecular-weight particles to carry the repellent compound, i.e., natural essential oil for continuous prolongation of the effect, the natural essential oil containing, as an active component, a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent.

According to the invention, in preparing an adhesive or bond or ink containing the slowly releasable repellent active organic high-molecular-weight particles, they can be used as a uniform dispersion of particles in which the sedimentation of particles is prevented.

The natural essential oil repellent active substance is forcedly spread around the periphery of a container by placing a uniform dispersion of particles, repellent pellets, a repellent sheet, a repellent film or repellent paper into a container, and by blowing the air toward the container with a fan, whereby the place can be protected from damage of sanitary insect pest over an extended area. This repellent dispersion can be widely used in food plants, cook rooms of restaurants, and household rooms.

The dispersion of particles thus prepared contains water or an organic solvent and a sedimentation inhibitor in addition to the particles. It is greatly desired to use a sedimentation inhibitor in order to disperse the particles carrying thereon a repellent compound of high gravity in an organic solvent or an aqueous emulsion. Usable as the sedimentation inhibitor are protein, polysaccharide, synthetic resins, an acrylic acid polymer and an inorganic substance.

The microcapsules of synthetic resin covering the natural essential oil of the invention have a microcapsule film wall highly resistant to solvents since an organic solvent is used as the solvent, the oil of the invention containing, as an active component, at least one of a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent.

Microcapsules are formed using a film-forming material such as urea formaldehyde resin, melamine formaldehyde resin or the like as disclosed, e.g., in Japanese Unexamined Patent Publications Nos. sho 53-84881; sho 53-84882; sho 60-28819; and sho 60-216838, or using a radical polymer prepared from a monomer component having unsaturated double bond (e.g., acrylonitrile, acryl amide, acrylic acid ester, N,N-methylenebis acryl amide as a crosslinking agent, etc.) as disclosed in Japanese Unexamined Patent Publication No. sho 61-40188.

Examples of the hydrophobic organic solvent to be used in the invention are toluene, xylene and like aromatic hydrocarbons, hexane, n-heptane, mineral spirit and like hydrocarbons. These solvents can be used either alone or in combination, or may be used in mixture with water. The composition ratio of the microcapsule composition of the invention is generally 20 to 30 parts by weight of the hydrophobic substance (natural essential oil) and 30 to 100 parts by weight of the organic solvent, per 100 parts by weight of the microcapsules.

The microcapsule composition of the invention can be prepared by dissolving a hydrophobic substance (natural essential oil) in a hydrophobic organic solvent, adding a microcapsule dispersion, and removing water from the system by azeotropic dehydration.

A printing ink can be produced, when required, by incorporating an adhesive, a protective material and stilt as a buffer into the microcapsule composition.

Inorganic porous particles to be used in the invention include, for example, those having high microcapsule strength which the present inventors developed (Japanese Examined Patent Publication No. sho 57-055454) (trade names Godball B-6C, A-11c, B-16C, B-25C, E6-C, D-11C, E-16C, E-2C, etc. produced by Suzuki Yushi Industrial Co., Ltd.). Further, use is made of Nipsil series or Laponite series (trade names, produced by Nihon Silica Kogyo Co., Ltd.), Aerosil 50, 90G, 130, 200, 200 FAD, 300, R 202, R 812R, OX 50, MOX 170 (trade names, Nippon Aerosil Co., Ltd.), Silysia 250, 256, 310, 320, 430, 530, 730, 770, etc. (trade names, produced by Fuji Silysia Chemical Co., Ltd.), Smectite SWN, SAN, STN, SEN, SPN, etc., (trade names, produced by Co-op Chemical Co., Ltd.), talc, kaolin, active clay, diatomaceous earth, pearlite, bentonite, etc. Inorganic porous particles (Japanese Examined Patent Publication No. sho 57-055454) are especially proper. The inorganic porous particles (Japanese Examined Patent Publication No. sho 57-055454) are advantageous in the following. Even when the particles are heated, the skeleton constituting porosity is not changed, which means that the sanitary insect pest repellent activity of copaiba oil and/or caryophyllene can be retained even if subjected to heating procedure during manufacture process.

Insofar as the inorganic porous particles suitable in the invention (Japanese Examined Patent Publication No. sho 57-055454) are concerned, the particles are allowed to carry a repellent active compound thereon either during the process of producing the inorganic porous particles or thereafter.

In the method wherein the repellent-active compound becomes supported on the particles after producing the inorganic porous particles, an oil-in-water type emulsion is prepared using an organic solvent and a surfactant in the aqueous solution of the inorganic compound (compound I: e.g. inorganic compound such as silicate or carbonate of alkali metal), and the emulsion is mixed with an aqueous solution of the foregoing inorganic compound and an inorganic compound giving rise to water-insoluble sedimentation (compound II: e.g. halide of alkaline earth metal and inorganic or organic acid), whereby a sedimentation reaction is caused on an interface of droplets to form inorganic grains, followed by removal of the by-product and surfactant, resulting in production of non-empty inorganic porous particles having or not having voids (Japanese Examined Patent Publications No. Hei 05-009133 and No. Sho 57-055454).

In the method wherein the repellent active compound becomes supported on the particles during the manufacture of porous particles, the repellent active compound is dispersed in the aqueous solution of the inorganic compound. Then the repellent active compound is embedded in the inorganic porous particles. In the invention, a uniform particle dispersion can be used by inhibiting the sedimentation of slowly releasable repellent active inorganic porous particles in preparing an adhesive or bond or ink containing slowly releasable repellent active inorganic porous particles.

The particle dispersion contains water or an organic solvent and a sedimentation inhibitor in addition to the inorganic porous particles. The particle dispersion needs to contain a sedimentation inhibitor since the dispersion has inorganic porous particles (e.g., inorganic porous particles composed of a silica component with a true gravity of 2.1) dispersed in an organic solvent or an aqueous emulsion and carrying a repellent compound of high gravity. Examples of the sedimentation inhibitor are protein, polysaccharide, a synthetic resin, an acrylic acid polymer and an inorganic substance. In the method wherein a repellent active compound becomes supported during the process of producing the inorganic porous particles (Japanese Examined Patent Publication No. Sho 57-055454), for example, the repellent active compound is dispersed in an aqueous solution having a concentration of 0.3 mol/liter to a saturated level and containing silicate of alkali metal (compound I) such as sodium silicate. Thereafter the dispersion is mixed with an organic solvent, such as toluene, having a surfactant, e.g. sorbitan monostearate dissolved therein at a dissolving power of preferably 5% or less in water, giving a W/o type emulsion. The emulsion is mixed with an aqueous solution (conc. 0.05 mol/liter to saturated level, preferably 0.1 to 2 mol/liter) of halide of alkaline earth metal such as calcium chloride which is capable of forming water-insoluble sedimentation (wall material), i.e. compound II. The solution is mixed with the emulsion at a ratio of the latter in chemical equivalent or more per 100 parts by weight of the former. In this way, the porous particles enclosing the repellent active compound in spherical inorganic wall (repellent active compound-calcium silicate) are produced.

The compound II for use in producing inorganic porous particles is soluble in water, free from adversely affecting the repellent compound, and capable of giving water-insoluble sedimentation by reaction with the compound I, and is selected according to the kind of the compound I as follows. That is, when silicate of alkali metal such as sodium, potassium or the like is used as the compound I, inorganic porous particles of calcium silicate, barium silicate, magnesium silicate or the like can be produced by using, as the compound (II), (1) halide of alkaline earth metal such as calcium, barium, magnesium or the like, e.g. chloride, bromide or the like. Inorganic porous particles of silica can be obtained by use of (2) sulfuric acid, hydrochloric acid or the like.

The compound I and the compound II may be reversely matched. When halide of alkaline earth metal such as calcium, barium, magnesium or the like, e.g. chloride, bromide or the like is used as the compound I, carbonate or hydrogen carbonate of alkali metal such as sodium, potassium or the like can be advantageously used as the compound II. By the reaction of these compounds, inorganic porous particles of calcium carbonate, barium carbonate or magnesium carbonate or the like are produced.

Preferred are porous particles of silica (silicic anhydride), calcium carbonate, barium carbonate, magnesium carbonate or the like. More preferred are porous particles of silica, calcium silicate or the like. In the second method, i.e. wherein the repellent-active compound becomes supported on the particles after producing the inorganic porous particles, at first, inorganic porous particles alone are formed without dispersing the repellent compound. Thereafter copaiba oil (1.0 kg) is added to the inorganic porous particles (1.5 kg). After sufficiently mixing them, the pressure is reduced to 10 torr. The mixture is left to stand for 10 minutes and then the pressure is gradually returned to an atmospheric level, whereby inorganic porous particles having copaiba oil supported thereon are produced. This method may be conducted for other porous particles of, e.g., talc, kaolin, active clay, diatomaceous earth, pearlite, bentonite or the like.

The inorganic porous particles have the following features, irrespectively of hollow or non-hollow particles. These particles have a particle size of 0.05 to 25 μm, an average surface pore diameter of 2 to 30 nm, a specific surface area of 10 to 1000 m²/g, and a bulk density of 0.1 to 0.8 g/cm³. The hollow inorganic porous particles may enclose 100 to 180 ml/100 g of liquid insect pest repellent, or insect pest repellent dissolved or dispersed in a solvent, whereas the non-hollow inorganic porous particles may include 50 to 175 ml/100 g of insect pest repellent dissolved or dispersed in a solvent.

The acrylic acid polymer to be used as a sedimentation inhibitor for the particles in the dispersion of particles is also termed polyacrylic acid and is prepared by polymerization of two or more kinds of acrylic acid. Especially crosslinking type acrylic acid polymer can be used. Specific examples of the acrylic acid polymer are Junlon series (PW-110 or PW-150 produced by Nihon Junyaku Co., Ltd.), Carbopole series (907 or 910 produced by Showa Denko Co., Ltd.) (Japanese Unexamined Patent Publication No. Hei 9-77605). The amount of the acrylic acid polymer in the dispersion is 0.0001 to 6 wt %, preferably 0.01 to 0.5 wt %.

An alkali agent may be added to the acrylic acid polymer for neutralization to thicken the mixture, making it water-insoluble or sparingly soluble in water. Useful alkali salts are sodium hydroxide, potassium hydroxide, ammonia water, morpholine and the like (Japanese Unexamined Patent Publication No. Hei 9-77605).

The amount of the alkali salt to be used should be sufficient to adjust the pH to 5.0 to 9.0, preferably 6.5 to 7.5 on neutralization, and is 0.00001 to 20 wt %, preferably 0.01 to 0.5 wt % although depending on the amount of the crosslinking-type acrylic acid polymer.

Examples of protein useful as the sedimentation inhibitor include water-soluble gelatin, water-insoluble casein, sodium casein, gluten, etc. Useful polysaccharides are a single substance of polysaccharide, derivatives thereof, etc. Examples are water-soluble gum arabic, gellan gum, xanthan gum, hydroxyethyl cellulose, carboxymethyl cellulose, hydroxypropyl cellulose, sailium gum, water-insoluble methyl cellulose, ethyl cellulose, acetic acid cellulose, curdlan, etc. Useful synthetic resins are water-soluble polyvinyl alcohol, polyvinyl pyrrolidone, etc. The amount is 0.1 to 20.0 parts by weight, preferably 1.0 to 10.0 parts by weight, more preferably 3.0 to 8.0 parts by weight, per 100 parts by weight of the particle dispersion.

Examples of the inorganic substance usable as the sedimentation inhibitor are kaolin, sericite, gariome clay, mica, synthetic mica, hydrophobic synthetic mica, bentonite, hydrophobic bentonite and like clay minerals, fine particles of silica, fine particles of alumina, etc. The amount of the substance is 0.1 to 20.0 parts by weight, preferably 5.0 to 12.0 parts by weight, more preferably 8.0 to 9.0 parts by weight, per 100 parts by weight of the dispersion.

The dispersion of repellent thus prepared can be used alone as a repellent, but usually as an aqueous suspension containing a thickener, an anti-freezing agent, an anti-septic agent, a gravity adjuster and the like. Examples of the thickener are xanthan gum, phamsan gum, locust bean gum, carrageenan, welan gum and like natural polysaccharides, sodium polyacrylate and like synthetic polymers, carboxymethyl cellulose, semi-synthetic polymers, aluminum magnesium silicate, smectites, bentonite, hectorite, dry silica and like mineral particles, alumina sol, etc. Useful anti-freezing agents include propylene glycol. Useful antiseptics are, for example, p-hydroxybenzoic acid ester, salicylic acid derivatives, etc. Useful gravity adjuster are sodium sulfate and like water-soluble salts, urea and like water-soluble fertilizers, etc. They can be used in the form of particles produced by spray dry method.

According to the invention, in preparing an adhesive or bond or ink having a slowly releasable repellent activity, the components can be used as a uniform dispersion of particles in which the separation is prevented.

The natural essential oil repellent active substance can be forcedly spread outward by placing into a container a uniform dispersion of particles, repellent pellets, a repellent sheet, a repellent film or repellent paper and by blowing the air toward the container with a fan, whereby the place can be protected from damage of sanitary insect pests over an extended area. This type of repellent can be widely used in food plants, cook rooms of restaurants, and household rooms.

The dispersion of natural repellent active essential oil thus prepared contains water or an organic solvent and/or a sedimentation inhibitor in addition to the natural essential oil. It is greatly desired to use a sedimentation inhibitor in order to disperse the particles carrying thereon a repellent compound of high or low gravity, in an organic solvent or an aqueous emulsion. Usable as the sedimentation inhibitor are protein, polysaccharide, synthetic resins, acrylic acid polymers and inorganic substances.

A printing ink can be produced, when required, by incorporating, e.g. an adhesive, a protective material or stilt as a buffer into the natural repellent active essential oil or the dispersion of natural repellent active essential oil.

Examples of the adhesive are products of natural resins, natural resin-modified products, shellac, rosin, hydrogenated rosin, rosin ester, maleic acid-modified rosin and like modified rosins. Useful synthetic resins include, for example, petroleum resins, nitrated cotton, ethylene-maleic acid resins, styrene-maleic acid resins, modified alkyd resins, phenolic resins, ethylene-vinyl acetate polymers, vinyl chloride-vinyl acetate polymers, acrylic resins, synthetic gums, etc.

Examples of the stylt are starch produced from cellulose powder, wheat, corns, potatoes, sweet potatoes, tapioca or like raw materials, oxidized starch prepared from the same and an oxidizing agent, esterified starch, typically acetylated starch, etherified starch, aldehyde starch and like starch derivatives, modified starch and like starch powder, talc, calcium carbonate, polystyrene resin powders and like anti-fouling stylts, etc. An ink may further contain, if necessary, a pigment, a thickener, wax and the like to improve the properties of the ink.

Using a printing ink containing natural repellent active essential oil prepared from a combination of the above-mentioned components, a printed matter can be produced by conventional printing methods such as flexo printing, screen printing, gravure printing and the like.

The slowly releasable porous particles of the invention can achieve a sustaining effect when directly added to an adhesive base material or an ink. A repellent is low in temporary and definite insecticidal effect compared with an insecticide so that the repellent is required to continue a repellent action to show a controlling effect. An adhesive or bond, ink, resin pellets, a resin product and sheet produced using the particles of the invention can continuously exhibit a repellent activity for a long term. The particles of the invention need not destroy the capsules for release of copaiba oil. Moreover, there is no need to form another layer for the repellent active compound. The repellent active compound can be directly included in the adhesive, ink, resin pellets, a resin product, a sheet or film or the like.

### BEST MODE FOR CARRYING OUT THE INVENTION

The repellent active compound of the invention can be applied to the following sanitary insect pests which hold on our foods and grains to spread infectious diseases, to eat away foods and to cause pains or disease in human bodies; such as cockroaches, flies, hypothesiums, deathwatches, indian meal moth, sawtoothed grain beetle, maize weevils, termites, beetles (grain weevils, red flour beetles and museum beetles), scale bugs, moths (clothes moths, and tineola bisselliella) and the like.

The acrylic acid polymer to be used as a dispersion stabilizer for the dispersion of particles, alias, polyacrylic acid, is prepared by polymerizing two or more kinds of acrylic acids. Especially a crosslinking type acrylic acid polymer can be used. Specific examples of the acrylic acid polymer are Junlon series (PW-110 and PW-150 produced by Nihon Junyaku Co., Ltd.), and Carbopole series (907 and 910 produced by Showa Denko Co., Ltd.) (Japanese Unexamined Patent Publication No. Hei 9-77605). The amount of the acrylic acid polymer in the dispersion is 0.0001 to 6 wt %, preferably 0.01 to 0.5 wt %.

An alkali agent may be added to the acrylic acid polymer for neutralization to thicken the mixture, making it insoluble or sparingly soluble in water. Useful alkali salts are sodium hydroxide, potassium hydroxide, ammonia water, morpholine and the like (Japanese Unexamined Patent Publication No. Hei 9-77605).

The amount of the alkali salt to be used should be sufficient to adjust the acrylic acid polymer to a pH of 5.0 to 9.0, preferably 6.5 to 7.5 by neutralization of the polymer, and is 0.00001 to 20 wt %, preferably 0.01 to 0.5 wt % although depending on the amount of the crosslinking-type acrylic acid polymer.

Further examples of the protein useful as a dispersion stabilizer include water-soluble gelatin, water-insoluble casein, sodium casein, gluten, etc. Useful polysaccharides are a single substance of polysaccharide, derivatives thereof, etc. Examples are water-soluble gum arabic, gellan gum, xanthan gum, hydroxyethyl cellulose, carboxymethyl cellulose, hydroxypropyl cellulose, psyllium gum, water-insoluble methyl cellulose, ethyl cellulose, acetic acid cellulose, curdlan, etc. Examples of the synthetic resin are water-soluble polyvinyl alcohol, polyvinyl pyrrolidone, etc. The amount is 0.1 to 20.0 parts by weight, preferably 1.0 to 10.0 parts by weight, more preferably 3.0 to 8.0 parts by weight, per 100 parts by weight of the particle dispersion.

Examples of the inorganic substance as the dispersion stabilizer are kaolin, sericite, gairome clay, mica, synthetic mica, hydrophobic synthetic mica, bentonite, hydrophobic bentonite, and like card house clay minerals, fine particles of silica, fine particles of alumina, etc. The amount of the inorganic substance is 0.1 to 20.0 parts by weight, preferably 5.0 to 12.0 parts by weight, more preferably 8.0 to 9.0 parts by weight, per 100 parts by weight of the particle dispersion.

The water or organic solvent and the mixture thereof to be used for the dispersion are capable of dispersing the slowly releasable repellent active particles. Examples of the organic solvent are alcohol, diethyl ether, and like ethers, acetone and like ketones, petroleum ethers, ethyl acetate and like esters, toluene and like aromatic solvents, although not limited thereto.

Method of Preparing a Dispersion (Dispersion Stabilizer: Acrylic Acid Polymer)

0.1 to 5.0 parts by weight, preferably 0.1 to 0.4 part by weight of acrylic acid polymer per 100 parts by weight of water or organic solvent is mixed with the latter to give a dispersion stabilizer (1). The natural essential oil contains, as an active component, at least one of: a first fraction of copaiba oil given by silica gel column chromatography using hexane as an elution solvent, a second fraction given by silica gel column chromatography using a 4:4:1 mixture of hexane/chloroform/ethyl acetate as an elution solvent, and a third fraction produced by fractionating the remnant of the second fraction using a 1:1 mixture of ethyl acetate/chloroform as an elution solvent. 1.0 to 5.0 parts by weight, preferably 2.5 to 3.5 parts by weight, of a surfactant useful as a dissolving auxiliary per part by weight of the total dispersion to give a dispersion (2).

The dispersion stabilizer (1) is gradually added to 100 parts by weight of the dispersion (2) to disperse the same. Then a suitable amount of sodium hydroxide is added per 100 parts by weight of the dispersion (2) to adjust a pH to 6.5 to 7.5.

Method of Producing a Dispersion (Dispersion Stabilizer: Protein)

Sodium casein is used as the dispersion stabilizer in an amount of about 0.1 to about 15.0 parts by weight, preferably about 1.0 to about 7.0 parts by weight, more preferably about 3.0 to about 5.0 parts by weight, based on the whole weight of the dispersion. The dispersion stabilizer solution (1) is prepared in the same manner as above and a dispersion is prepared.

Method of Producing a Dispersion (Dispersion Stabilizer: Inorganic Substance)

For example, bentonite is used as the dispersion stabilizer in an amount of about 0.1 to about 15 parts by weight, preferably about 3.5 to about 10.5 parts by weight, more preferably about 6.5 to about 8.5 parts by weight, based on the whole weight of the dispersion. A dispersion stabilizer solution (1) is prepared in the same manner as above and a dispersion is prepared.

Method of Producing a Particle Dispersion (Sedimentation Inhibitor: Protein)

Sodium casein is used as the sedimentation inhibitor in an amount of about 0.1 to about 15.0 parts by weight, preferably about 1.0 to about 7.0 parts by weight, more preferably about 3.0 to about 5.0 parts by weight, based on the whole weight of the particle dispersion. A sedimentation inhibitor solution (1) is prepared in the same manner as above and a particle dispersion is prepared.

Method of Producing a Particle Dispersion (Sedimentation Inhibitor: Inorganic Substance)

For example, bentonite is used as the sedimentation inhibitor in an amount of about 0.1 to about 15 parts by weight, preferably about 3.5 to about 10.5 parts by weight, more preferably about 6.5 to about 8.5 parts by weight, based on the whole weight of the particle dispersion. A sedimentation inhibitor solution (1) is prepared in the same manner as above and a particle dispersion is prepared.

Method of Producing a Particle Dispersion (Sedimentation Inhibitor: Acrylic Acid Polymer)

For example, an acrylic acid polymer is mixed as the sedimentation inhibitor in an amount of about 0.1 to about 5.0 parts by weight, preferably about 0.1 to about 0.4 part by weight, per 100 parts by weight of water or an organic solvent to give a sedimentation inhibitor solution (1). Copaiba oil and/or caryophyllene is mixed with a surfactant as a dissolving auxiliary in an amount of about 1.0 to 5.0 parts by weight, preferably about 2.5 to about 3.5 parts by weight, per part by weight of the whole of the repellent solution to give a repellent solution (2).

Into a low-pressure rapid stirrer is placed about 50 to about 200 parts by weight of inorganic porous particles per 100 parts by weight of the repellent solution (2). Thereto is added 100 parts by weight of the repellent solution (2). The mixture is fully mixed. The pressure is reduced to about 10 torr after which the mixture is left to stand for 10 minutes. Then the atmospheric pressure is brought back slowly. This operation is repeated from twice to 10 times, whereby a repellent solution (2)-supporting silica microcapsules MC(3) (i.e. slowly releasable repellent active inorganic porous particles) are obtained. The obtained MC (3) is slowly added to the sedimentation inhibitor solution (1), and is mixed and dispersed well. Then a suitable amount of sodium hydroxide is added to control a pH to 6.5 to 7.5, giving a particle dispersion.

Method of Producing a Particle Dispersion (Sedimentation Inhibitor: Protein)

Sodium casein is used as the sedimentation inhibitor in an amount of about 0.1 to about 15 parts by weight, preferably about 1.0 to about 7.0 parts by weight, more preferably about 3.0 to about 5.0 parts by weight, based on the whole weight of the particle dispersion. A sedimentation inhibitor solution (1) is prepared in the same manner as above and a particle dispersion is prepared.

Method of Producing a Particle Dispersion (Sedimentation Inhibitor: Inorganic Substance)

For example, bentonite is used as the sedimentation inhibitor in an amount of about 0.1 to about 15 parts by weight, preferably about 3.5 to about 10.5 parts by weight, more preferably about 6.5 to about 8.5 parts by weight, based on the whole weight of the particle dispersion. A sedimentation inhibitor solution (1) is prepared in the same manner as above and a particle dispersion is prepared.

A proper amount of the natural repellent active essential oil and/or the dispersion (containing organic and inorganic particle dispersion) is added to components constituting an adhesive. The mixture is applied to a tape base material, giving a repellent active compound-containing adhesive. The natural repellent active essential oil and/or the dispersion is added to components constituting an ink, giving a repellent active compound-containing ink.

The dispersion of the invention (as described above; omitted hereinafter) is added to a solvent type or aqueous adhesive for use in producing conventional labels (tacks), packaging tapes, masking tapes or the like or to an adhesive for multi-layer films, giving a repellent active compound-containing adhesive.

The natural repellent active essential oil and/or the dispersion according to the invention can be added to adhesives conventionally used. The adhesives conventionally used may contain natural rosin (pine resin) chiefly containing an acrylic resin. The particle dispersion of the invention is incorporated into an adhesive having the formulation conventionally employed. The amount of the particle dispersion is 0.01 to 30% by weight, more preferably 0.1 to 10% by weight, most preferably 3 to 5% by weight, based on the whole weight of the adhesive.

The repellent active compound-containing adhesive can be spread over holding materials conventionally used in the art. The following holding materials can be employed but are not limited thereto. Sheets or labels (tacks) can be produced by spreading and retaining the adhesive on the following holding materials: papers (wood-free papers, mirror-coat papers, art papers, recycled papers, foils, synthetic papers, heat-sensitive papers and Japanese papers), films (PP, PET or OPP for laminate/PET or OPP), synthetic papers, chemical papers, foils and the like. Packaging tapes and masking tapes can be produced by spreading and retaining the adhesive on the following holding materials: kraft papers, Japanese papers, synthetic papers, fabrics, non-woven fabrics, films (PP, PET or OPP), etc. Mar-resistant tapes can be produced by spreading the adhesive on fabrics, non-woven fabrics, papers, synthetic papers, chemical papers, films and so on. The adhesive can be applied to synthetic films (hotmelt adhesion) and mult-layer films. Furthr the adhesive can be used for hygienic materials, e.g., adhesive bandages, fabrics and so on. In producing these articles, care should be taken so that at least one surface of the holding materials may be porous to release the repellent active compound from the adhesive.

Inks usually used which contain natural repellent active essential oil and/or the dispersion according to the invention are not limited insofar as they are usually used in the art. These inks are mainly acrylic resin-based, solvent type or aqueous type (emulsion). For example, they are aqueous inks (emulsion) to be used in flexo, printer sloetter, gravure or silk-screen printing, UV processing, surface coating and so on; oily inks(solvent-type) to be used in flexo, gravure, silk-screen or offset printing, UV processing, surface coating and so on. The ink can be added to a dispersion having water repellency. Further the inks may be those containing protein as a base material, and vegetable inks containing a fat oil such as soybean oil as a base material.

To the ink having the formulation conventionally utilized is added the natural repellent active essential oil and/or the dispersion of the invention in an amount of 0.1 to 30 wt %, preferably 0.1 to 10 wt %, more preferably 3 to 5 wt %, based on the total weight of the ink.

Articles printed with the ink of the invention include the following articles conventionally printed in the art but are not limited thereto: paper containers, corrugated cardboards, rear side materials of Japanese mat, packaging papers, paper bags, wall papers, pocket handkerchiefs, paper towels, paper napkins, paper diapers, paper blinds, rubbish bags, paper bags for vegetables and like paper articles, wood articles, building interior decoration materials, sheet or film articles, petroleum resin moldings, biodegradable resin moldings, which can exhibit repellent active effect.

The natural repellent active essential oil and/or the dispersion may not be changed even by heating depending on the kinds of polymers to be added. In view of the above, they can be incorporated into resin pellets being heated. For example, when instant foods or retort foods can be packaged with films formed of insect repellent resin pellets, the foods can be displayed for sale or stored without access from insect pests for a long time.

The kinds of pellet resins into which the natural repellent active essential oil and/or the dispersion are included are as follows: nylon (polyamide), ethylene-vinyl alcohol copolymer resins, polyolefin-based heat-shrinkable resins, acrylic resins, polyester resins, polyvinylidene chloride resins, heat shrinkable fluorine resins, polystyrene resins, polyethylene resins, and so on. which are not limited insofar as the essential oil can be included into the resins. Non-stretchable films, stretched films or sheets and resin moldings can be produced using pellets having the natural repellent active essential oil and/or the dispersion included therein.

Examples of the resin to be used for resin pellets and resin articles produced from the resin pellets (the resin articles being remarked in angulated parenthesis) are as follows: PE (polyethylene resins); PP (polypropylene resins); PET (polyethylene terephthalate) [blister packaging, capsules and tablets]; PBT (polybutylene terephthalate); PVAc (polyvinyl acetate); PA (polyamide)[nursing bottles and coffee filter papers]; PMMA (methyl polymethacrylate); acrylic acid resins; methacrylic resins [signboard, display, windshield glass, lighting apparatus and miscellaneos goods]; ABS (acrylonitrile-butadiene-styrene); AS resins (acrylonitrile-styrene copolymer resins) [lunch boxes and containers]; SI (silicon); SBR (styrene-butadiene rubber); EP (epoxy resins); PC (polycarbonate); [electromechanical parts, miscellaneous goods, windowpanes and packaging films]; polyacetal (gears, automotive parts and office equipment parts); polyurethane; polysulfone [electrical parts and miscellaneous goods]; PF (phenolic resins) [dishes, knobs and bowls]; MF (melamine resins) [tableware and chopsticks]; PUR (urethane resins)[soup bowls]; UP (unsaturated polyester resins)[microwave ovens and containers for ovens]; saturated polyester resins [packaging materials, transcription foil for roll-leaf hot stamping]; polyether; polyamide [fibers and mechanical parts]; PTFE (fluorine resins); PMT (polymethyl pentene)[medical articles, articles for tableware], and DAP (diallyl phthalate resins) [smoothly planed boards and electrical insulating-materials].

The natural repellent active essential oil and/or the dispersion is added to the resin pellets in an amount of 0.01 to 30 wt %, more preferably 0.1 to 20 wt %, most preferably 0.5 to 10 wt %, based on the whole weight of resin pellets. As a result, if the final product has the natural repellent active essential oil and/or the dispersion in an amount of 0.01 to 30 wt %, more preferably 0.1 to 20 wt %, most preferably 0.5 to 10 wt %, based on the whole weight of the resin pellets, the product can retain sanitary insect pest repellent activity.

The natural repellent active essential oil and/or the dispersion can be incorporated into sheets or films. Examples of the sheet are paper, non-woven fabrics, natural fiber fabrics, chemical fiber fabrics, etc. Examples of the films are transparent pouches, transparent tray, aluminium foils, shrink films, overlaps, etc.

The natural repellent active essential oil and/or the dispersion can be incorporated into various kinds of paper. They may be included therein in making paper. Examples of the paper are corrugated cardboards, cardboards, thick papers, papers (wood-free papers, mirror coated papers, art papers, recycled papers, foils, synthetic papers, heat-sensitive papers, Japanese papers, chemical-fiber papers, etc.), fabrics, non-woven fabrics, films, etc.

Non-woven fabrics are, for examples, those of nylon, acryl, polyester, cotton, rayon or the like. Special papers include glass fiber papers produced by a mixing type paper-making method to make glass fibers into uniform inorganic fibers. The product of inorganic fibers are a mixed product of heat-insulating materials [vinylon/ceramic paper (organic and inorganic binders)] and pulps.

In the case of chemical fibers, the repellent resin pellets containing the natural repellent active essential oil and/or the dispersion are added to raw material of filaments and threads to give yarns which can be made into a fabric. Examples of the chemical fibers are those made from acryl, cellulose, acetate, vinylon, nylon, vinylidene chloride, polyester, and so on.

Natural fibers such as those made of cotton, flax or silk and the foregoing chemical fibers are made repellent by applying the repellent resin pellets to the fibers through a spray in spinning or by immersing the fabric in the natural repellent active essential oil and/or the dispersion after forming the fabric.

A variety of insect pest repellent articles can be produced using the above-mentioned sanitary insect pest repellent active sheets or films. Examples are corrugated cardboards, paper containers, packaging papers or boxes, middle-size packaging paper, buffer materials and like packaging materials for containing foods, such as boxes made of corrugated cardboards, rear side materials of Japanese mats, paper bags (sheet), paper handkerchiefs (sheet), paper towels (sheet), paper napkins (sheet), paper blinds (sheet), bags for containing rubbish (sheet), bags for containing vegetables (sheet), wall papers, building interior materials, sheets or films which can exhibit insect pest repellent effect.

The natural repellent active essential oil and/or the dispersion are incorporated into sheets or films in an amount of 0.01 to 90 wt %, more preferably 0.1 to 50 wt %, most preferably 0.5 to 30 wt %, based on the total weight of the sheet or film.

### EXAMPLE 1

A 3% solution of copaene (abounding in copaiba balsam produced in the Philippines) in a 1:1 solvent mixture of hexane/acetone.

### EXAMPLE 2

A 3% solution of trans-α-bergamoten (abounding in lemon essential oil/bergamot essential oil produced in Italy).

### EXAMPLE 3

A 3% solution of garmacrene-D (abounding in bergamot essential oil/copaiba essential oil) in the same solvent mixture as above.

### EXAMPLE 4

The same solution as above except that GALMACREN-beta was used as an organic component in Example 3.

### EXAMPLE 5

A 2.5% solution of Delta-Cadinene (abounding in cedarwood essential oil) in the same solvent mixture as above.

### EXAMPLE 6

A 3% solution of cis-CARAMENEN (abounding in URAMEN essential oil) as an active component used in Example 5

### EXAMPLE 7

A 3% solution of α-caryophyllene alcohol (abounding in clove leaf essential oil) in the same solvent mixture as above.

### EXAMPLE 8

Production of dispersion (A)

| | Wt % |
|---|---|
| Copaiba balsam | 3 |
| (copaene-containing, produced | |
| in the Philippines) | |
| Sodium polyacrylate | 0.5 |
| Purified water | Proper amount |
| | 100 |

### EXAMPLE 9

Production of dispersion (B)

| | Wt % |
|---|---|
| Lemon essential oil (containing | 2 |
| trans-α-bergamoten and produced | |
| in Italy) | |
| Sodium alginate | 1 |
| Polyoxyethylene sorbitan | 2 |
| monolaurate | |
| Sodium metaphosphate | 2 |
| Purified water | Proper amount |
| | 100 |

The dispersion (B) was produced from the above-listed components in the same manner as above.

### EXAMPLE 10

Production of dispersion (C)

| | Wt % |
|---|---|
| Bergamot essential oil (containing | 4 |
| garmacrene-D and -β) | |
| Methyl cellulose | 1 |
| Polyoxyethylene alkyl ether | 1 |
| Polyglycerin fatty acid ester | 1 |
| Potassium metaphosphate | 1 |
| Polyvinyl pyrrolidone | 3 |
| Purified water | Proper amount |
| | 100 |

The dispersion (C) was produced from the above-listed components in the same manner as above.

### EXAMPLE 11

Production of dispersion (D)

| | Wt % |
|---|---|
| Clove leaf essential oil | 5 |
| (containing α-caryophyllene alcohol) | |
| Zinc pyrithione | 5 |
| Aromatic dialkyl carboxylic | 25 |
| acid ester | |
| Hydrophobic mica | 10 |
| Toluene | Proper amount |
| | 100 |

### EXAMPLE 12

Production of dispersion (E)

| | Wt % |
|---|---|
| Cedarwood essential oil | 5 |
| (containing Delta-Cadinene) | |
| Polyoxyethylene alkyl ether | 1 |
| Ethyl acetate | Proper amount |
| | 100 |

### EXAMPLE 13

Method of producing a repellent active adhesive Each of the dispersions prepared in Examples 8 to 12 was added in an amount of 3 wt % to an acrylic resin-based adhesive of 50% aqueous emulsion solution containing an acrylic resin and natural rosin (pine resin) at a ratio of 95:5, and was mixed well, whereby a sanitary insect pest repellent active adhesive was obtained.

### EXAMPLE 14

The same as described above.

### EXAMPLE 15

The same as described above.

### EXAMPLE 16

The same as described above.

### EXAMPLE 17

Production of aqueous repellent active flexo ink

| | Wt % |
|---|---|
| Pigment (red) | 20 |
| Acrylic resin (main component) | 30 |
| Water | 49 |
| Diethanolamine | 1 |

The above-mentioned components were mixed together to give an aqueous flexo ink. The dispersion (A) produced in Example 8 was added in an amount of 5 wt % or 10 wt % to the flexo ink, producing a repellent active flexo ink.

### EXAMPLE 18

Production of repellent active flexo clear ink

| | Wt % |
|---|---|
| Acrylic resin (main component) | 40 |
| Water | 60 |

The above-mentioned components were mixed together to give an aqueous flexo clear ink. The dispersion (B) produced in Example 9 was added in an amount of 5 wt % or 10 wt % to the aqueous flexo clear ink, producing a repellent active flexo clear ink.

### EXAMPLE 19

Production of repellent active printer sloetter ink

| | Wt % |
|---|---|
| Pigment (blue) | 20 |
| Acrylic resin (main component) | 20 |
| Ethylene glycol | 20 |
| Glycol | 20 |
| Amino alcohol | 5 |
| Ethyl alcohol | 12 |
| Other auxiliaries | 3 |

The above-mentioned components were mixed together to give a Printer sloetter ink. The dispersion (C) produced in Example 10 was added in an amount of 5 wt % or 10 wt % to the ink, producing a repellent active printer sloetter ink.

### EXAMPLE 20

Production of oily flexo ink

| | Wt % |
|---|---|
| Pigment | 20 |
| Polyamide-based resin | 15 |
| Toluene | 35 |
| Methyl ethyl ketone | 10 |
| Isopropyl alcohol | 20 |

The above-mentioned components were mixed together to give an oily flexo ink. The dispersion (D) produced in Example 11 was added in an amount of 5 wt % or 10 wt % to the flexo ink, producing a repellent active oily flexo ink.

### EXAMPLE 21

Production of UV ink for overprint

| | Wt % |
|---|---|
| Epoxy acrylate (oligomer) | 50 |
| 1,6-Hexanediol diacrylate | 8 |
| Trimethylolpropane triacrylate | 30 |
| 2-Hydroxy-2-methylpropiophenone | 6 |
| 2,2-Dimethoxy-2-phenyl acetophenone | 4 |
| Wax | 1 |
| Diethanolamine | 1 |

The above-mentioned components were mixed together to give a UV ink for overprint. The dispersion (E) produced in Example 12 was added in an amount of 5 wt % or 10 wt % to the UV ink for overprint, producing a repellent active oily flexo ink.

### EXAMPLE 22

Production of Repellent Polypropylene Pellets

Polypropylene resin pellets (product of Showa Denko Co., Ltd., Sunallomer PF621S) were filled at a filling rate of 9 kg/h along with trans-a-bergamotene at a filling rate of 1 kg/h by use of a double screw extruder at 200 to 220° C. and kneaded together, giving repellent polypropylene pellets carrying 10 wt % of trans-α-bergamotene measuring about 2 mm (diameter)×about 3 mm.

### EXAMPLE 23

Production of 5% Garmacrene-D-Carrying Film

Fifty wt % of polypropylene resin pellets (product of Showa Denko Co., Ltd., SUNALLOMER PF621S) and 50 wt % of repellent polypropylene resin pellets prepared in the same manner as in Example 22 were mixed together by a stirrer. A mixture of garmacrene-D-containing polypropylene resin pellets was made into a repellent polypropylene resin tube-shaped film carrying 5% garmacrene-D and having a film thickness of 20 μm and a width of 210 mm using a water-cooling inflation extruder (product of Yamaguchi Mfg., YP500NC) operated at 205 to 220° C. for about 5 seconds at a drawing rate of 30 m/min.

### EXAMPLE 24

Production of a 2.5% Delta-Cadinene-Carrying Film

75 wt % of polypropylene resin pellets (product of Showa Denko Co., Ltd., SUNALLOMER PF621S) and 25 wt % of repellent polypropylene resin pellets prepared in the same manner as in Example 23 were mixed by a stirrer. The obtained mixture of repellent polypropylene resin pellets was made into a repellent polypropylene resin tube-shaped film carrying 2.5% and having a film thickness of 20 μm and a width of 210 mm using a water-cooling inflation extruder (product of Yamaguchi Mfg., YP500NC) operated at 205 to 220° C. for about 5 seconds at a drawing rate of 30 m/min.

### EXAMPLE 25

Inclusion of Repellent Into Paper During Manufacture of Paper

Ten g of α-caryophyllene alcohol was dispersed in 500 ml of a 1% solution of polyvinyl alcohol. Paper fabric (mixed yarn of pulp and Manila hemp) measuring 20 cm×20 cm×0.4 cm² was immersed in the dispersion to provide a coat weighing about 2 to about 3 g/cm² on the paper fabric. Then the paper was dried, giving ant-repellent paper coated with neem oil.

### EXAMPLE 26

Production of repellent active coating composition

| | Wt % |
|---|---|
| Vinyl acetate-ethylene-acrylic resin | 20 |
| (main component) | |
| Aomori hinoki oil | 30 |
| Water | 50 |

5 wt % or 10 wt % of copaiba balsam was added to the above-described components, whereby a repellent active coating composition was prepared.

### EXAMPLE 27

Device for Repellency of Insect Pest

Into a container were placed natural repellent active essential oil and/or a dispersion (including an organic and particulate dispersion), repellent pellets, a repellent sheet, a repellent film, repellent paper or the like, which were left to stand or were forcedly spread by blowing the air to the periphery of the container with a fan to increase the dispersing efficiency. The device was capable of protecting the site from damage of sanitary insect pests over a wider area.

FIG. 1 shows the device.

In FIG. 1, a terminal for detecting an amount of water is designated 1. An inlet is designated 2. Indicated at 3 is a repellent; at 4, an outlet; at 5, a vapor duct; at 6, a hold for hand; and at 7, a tank.

### TEST EXAMPLE 1

### Test for Repellency of Mites on Adhesive (Method of Hindering Mites' Intrusion)

The adhesive prepared in Example 14 was tested for mite repellency by the following common test method, i.e. a method of obstructing mites' intrusion.

1. Method and Materials

(1) A specimen 10 cut out in a circular shape of 3.5 cm in diameter was spread on an internal bottom surface of a petri dish 8 having an internal diameter of 3.5 cm and a height of 1 cm, as shown in FIG. 2.

Practically in the center of the bottom surface of the petri dish 8 was placed 0.05 g of a bait 9 for allurement of mites (1:1 mixture of powdery feed for rearing small animals MF [product of Orient Kobo Co., Ltd.] and dried yeast as specified in the pharmacopoeia [product of Asahi Beer Co., Ltd.]).

The sheet of the bait was laid closely on the bottom surface.

(2) The petri dish 8 described in (1) was disposed in the center of a petri dish 12 made of glass having an internal diameter of 8.5 cm and a height of 2 cm.

A mite's medium 11 was disposed at a space between the petri dish 8 (3.5 cm in internal diameter) and the petri dish 12 (8.5 cm in internal diameter), not on the entire surface but around the petri dish 8 of 3.5 cm in internal diameter.

(3) With the test condition set as above, mites were left free on the medium 11 in the petri dish 12 of 8.5 cm in internal diameter. The set of dishes was placed into a thermostatic chamber at 25±5° C. in the total darkness.

(4) In 24 hours, there was counted the number of live mites coming onto the specimen 10 in the petri dish 8 of 3.5 cm in internal diameter. Thereby the effect was evaluated.

(5) The control plot was taken as a blank (the specimen in a treated plot would not be used if it would originally achieve more or less the intended degree of insect pest repellency). When a specimen exhibited 70% repellency in a treated plot, the specimen was evaluated as repellent.
Repellency ratio=(number of live mites moving in the control plot−number of live mites moving in the treated plot)/number of live mites moving in the control plot×100

In the test, repellency ratio was calculated based on the number of mites coming onto the adhesive surface of kraft tape as to the control (without the repellent compound), and the data immediately after production (T=0), 6 months thereafter (T=6), or 12 months thereafter (T=12).

TABLE 1
[Test Example 1] Mite repellency test on adhesive (method
of preventing intrusion)

| | Number of incoming | | Repellency |
|---|---|---|---|
| Specimen | mites | | ratio (%) |
| Control plot | (1) | 1298 | — |
| without active | (2) | 1321 | |
| compound | (3) | 1350 | |
| | Total | 3969 | |
| T = 0 | (1) | 270 | 80.1 |
| | (2) | 255 | |
| | (3) | 284 | |
| | Total | 789 | |
| T = 6 months | (1) | 148 | 89.6 |
| | (2) | 135 | |
| | (3) | 170 | |
| | Total | 453 | |
| T = 12 months | (1) | 312 | 72.8 |
| | (2) | 305 | |
| | (3) | 298 | |
| | Total | 915 | |

Number of mites coming onto each specimen in kraft tape and repellency ratio (%)

4. Consideration

In view of the highest repellency ratio achieved 10 after 6 months, presumably the repellent active substance was increasingly released after commencement of use of kraft tape, followed by decreased release.

### TEST EXAMPLE 2

### Mite Repellency Test on Adhesive

The following particle dispersion free of a repellent active substance was prepared in the same manner to provide a control. A mite repellency test was conducted using the control.

2. Specimen

The control and each repellent active adhesive of Examples 13 to 16 were used with tack seal.

3. Test Method

The test was carried out using a device shown in FIG. 3. Placed on the bottom surface of a container 14 of 30 cm in diameter was “specimen paper” in a circular shape of 30 cm in diameter. A cylindrical plastic container 17 having an inlet covered with aluminum foil was laid over a specimen 16. Thirty adults of Croton bugs were set free into the inside of the container and were left to stand at room temperature of 25° C. for 24 hours. The number of mites on the paper was counted, whereby the repellency ratio (%) in the treated control plot (where the specimen paper was placed) and in the untreated control plot (blank) was calculated. The test was twice repeated under the same conditions. An average value in the two tests was indicated. The use of the overlaid plastic container means that the test was carried out in view of the mites' favor of a dark place and their inclination of making their way to a light-shielded container after release in a light area of the container of 30 cm in diameter (additionally the test was conducted three times). Indicated at 13 was vaseline; at 15, water and at 18, the specimen.

4. Test Insects

Thirty adult Croton bugs

5. Test Results

The test results obtained after 24 hours are shown in Table 2.

TABLE 2
[Test Example 2] Mite repellency test on adhesive

| | Repellency ratio (%) |
|---|---|
| Example 13 | 78.5 |
| Example 14 | 77.9 |
| Example 15 | 82.1 |
| Example 16 | 80.5 |

The tested area was an adhesive surface in its entirety.

6. Consideration

A high repellent effect was exhibited as a whole.

### TEST EXAMPLE 3

### Indian Meal Moth Repellency Test by Ink Test Method for Repelling Indian Meal Moth

The test was conducted by a method shown in FIG. 4. A treated specimen 19 of about 13 cm (length)×10 cm (width) was placed over one end (half the floor surface) of a bottom surface in a plastic container of 13 cm (length)×20 cm (width)×8 cm (depth). A shelter 21 of 10 cm×5 cm formed by folding a treated specimen of 10 cm×10 cm into a corrugated form was laid (A) on the treated specimen 19 with the treated surface upturned. On the other half area was placed an untreated specimen 20 of about 13 cm (length)×10 cm (width). Laid thereover (B) without overlapping the corrugation (A) was a shelter 22 of 10 cm×5 cm formed by folding an untreated specimen of 10 cm×10 cm into a corrugated form.

On a central upper surface of each shelter was laid 0.5 g of a powdery feed (product of Asahi Beer Co., Ltd., dried yeast powder particles) as an alluring bait 24. Then, 15 of test insects 23 were made free in the center of the container 25. The insects were allowed to stand for 24 hours in the container at 25° C. and a humidity of 60% in the total darkness in an open state. The number of insects moving only in the areas (A) and (B) (10 cm×10 cm) were counted.

[Method of Calculation of Repellency Ratio]
Repellency ratio (%)=number of moving in control plot-number of insects moving in treated plot/number of insects moving in control plot×100

1. Test specimen (ink coating)

| Ex. No. | Ink used | Addition ratio (%) |
|---|---|---|
| 17 | flexo/red | 5 |
| | flexo/red | 10 |
| 18 | clear ink | 5 |
| | clear ink | 10 |
| 19 | printer sloetter ink/blue | 5 |
| | printer sloetter ink/blue | 10 |
| 20 | oily flexo | 5 |
| | oily flexo | 10 |
| 21 | overprint UV ink | 5 |
| | overprint UV ink | 10 |

TABLE 3
[Test Example 3] Test for Indian meal moth Repellency by Ink

| | Conc | Treated plot | | | Control plot | | | Repellen-cy |
|---|---|---|---|---|---|---|---|---|
| | % | F | R | Tot | F | R | Tot | ratio |
| Example 17 | 5 | 2 | 2 | 4 | 2 | 8 | 10 | 60.0 |
| Aqueous flexo ink | 10 | 1 | 1 | 2 | 3 | 7 | 10 | 80.0 |
| Example 18 | 5 | 1 | 2 | 3 | 3 | 9 | 14 | 75.0 |
| Flexo clear ink | 10 | 1 | 1 | 2 | 4 | 9 | 13 | 84.6 |
| Example 19 | 5 | 2 | 2 | 4 | 4 | 7 | 11 | 63.6 |
| Printer sloetter ink | 10 | 1 | 1 | 2 | 3 | 8 | 11 | 81.8 |
| Example 20 | 5 | 2 | 2 | 4 | 2 | 9 | 11 | 63.6 |
| Oily flexo ink | 10 | 0 | 1 | 1 | 4 | 8 | 12 | 91.7 |
| Example 21 | 5 | 1 | 2 | 3 | 3 | 8 | 11 | 72.7 |
| Overprint UV ink | 10 | 2 | 0 | 2 | 3 | 10 | 13 | 84.6 |

F: Front side
R: Rear side
Tot: Total
conc = concentration

### TEST EXAMPLE 4

### Test for Insect Pest Repellent Film

Test insect: Deathwatch (middle age larva)

Film: polypropylene

Shrink conditions: non-heating

Production of Film to be Used in Control Plot

A repellent polypropylene resin tube-shaped film having a film thickness of 20 μm and a width of 210 mm was prepared from polypropylene resin pellets (product of Showa Denko Co., Ltd., SUNALLOMER PF621S) using a water-cooling inflation extruder (product of Yamaguchi Mfg., YP50NC) operated at 205 to 220° C. for about 5 seconds at a drawing rate of 30 m/min.

Test Specimen

Repellent films of Examples 23 and 24

Test Method

Conducted in the same manner as in Test Example 3.

Test Results

TABLE 4
[Test Example 4] Test for repellency of repellent film

| | | | Repellency |
|---|---|---|---|
| | Treated | Control | ratio |
| | plot | plot | (%) |
| Example 23 | 12 | 88 | 86.4 |
| 5% Garmacrene-D- | | | |
| carrying film | | | |
| Example 24 | 15 | 82 | 81.7 |
| 2.5% Delta-Cadinene | | | |
| carrying film | | | |

### TEST EXAMPLE 5

### Physiological Activity (Croton Bug Repellency) Test

Test Compound

A fraction 1 (16.192 g) of copaiba oil was given by silica gel column chromatography (replenishment silica gel: BW-127ZH, 350 g) using 3 liter of hexane as an elution solvent. A fraction 2 (2.868 g) was given by silica gel column chromatography (same as above) using a 4:4:1 mixture of hexane/chloroform/ethyl acetate as an elution solvent. A fraction 3 (1.401 g) was given by fractionating the remnant of the fraction 2 using a 1:1 solvent mixture of ethyl acetate/chloroform 21 as an elution solvent.

For comparison, the same test was conducted using copaiba oil and β-caryophyllene. The specimen was a 3% solution in the solvent. The solution was given using a 1:1 (volume ratio) mixture of hexane and acetone.

Results

TABLE 5
[Test Example 5] <Physiological activity (repellency
of Croton bug)test>

| | Repellency ratio | | |
|---|---|---|---|
| | (%) with time | | |
| Repellent | 4 hours | 24 hours | 48 hours |
| Copaiba oil | 95 | 86.7 | 61.4 |
| β-caryophyllene | 96.2 | 70.6 | 52.6 |
| Fraction 1 | 93.1 | 76.1 | 63.9 |
| Fraction 2 | 82.2 | 86.9 | 71.8 |
| Fraction 3 | 69.3 | 54.5 | 49.0 |

### EXAMPLE 28

Particle Production Example 1

Lemon essential oil (100 g) was added to a mixture of 100 g of phenylxylyl ethane and 100 g of diisodecyl adipate. Then the mixture was finely divided by a bead mill to give a suspension having a concentration of about 31 wt % in terms of solid content. The suspension was mixed with 25 g of SMIJULE L-75, and added to 500 g of water containing 30 g of gum arabic and 20 g of ethylene glycol. The mixture was stirred at an ordinary temperature by T.K. autohomomixer (homogenizer produced by Tokushu Kikakogyo Co., Ltd.) to give fine droplets, which were stirred at 60° C. for 24 hours, thereby giving a slurry containing diniconazole suspended in a mixture of phenylxylyl ethane and diisodecyl adipate and micro-encapsulated with a polyurethane film. Added to the slurry was 175 g of water containing 1 g of xanthan gum and 5 g of aluminum magnesium silicate, whereby 10 wt % of a lemon essential oil capsule composition was obtained.

### EXAMPLE 29

Particle Production Example 2

Bergamot essential oil (50 g) was added to 200 g of phenylxylyl ethane. Then the mixture was finely divided by a bead mill to give a suspension having a concentration of about 19 wt % in terms of solid content. The suspension was mixed with 10 g of SMIJULE L-75, and added to 500 g of water containing 30 g of gum arabic and 20 g of ethylene glycol. The mixture was stirred at an ordinary temperature by T.K. autohomomixer to give fine droplets, which were stirred at 60° C. for 24 hours, thereby giving a slurry containing bromobutyde suspended in phenylxylyl ethane and micro-encapsulated with a polyurethane film. Added to the slurry was 240 g of water containing 1 g of xanthan gum and 5 g of aluminum magnesium silicate, whereby 5 wt % of a bergamot essential oil capsule composition was produced.

### EXAMPLE 30

Particle Production Example 3

Clove leaf essential oil (100 g) was added to a mixture of 100 g phenylxylyl ethane and 100 g of diisodecyl adipate. Then the mixture was finely divided by a bead mill to give a suspension having a concentration of about 31 wt % in terms of solid content. The suspension was mixed with 25 g of SMIJULE L-75, and added to 490 g of water containing 30 g of gum arabic. The mixture was stirred at an ordinary temperature by T.K. autohomomixer to give fine droplets, which were stirred at 60° C. for 24 hours, thereby giving a slurry containing diniconazole suspended in a mixture of phenylxylyl ethane and diisodecyl adipate and micro-encapsulated with a polyurea film. Added to the slurry was 185 g of water containing 1 g of xanthane gum and 5 g of aluminum magnesium silicate, whereby 10 wt % of a clove leaf essential oil composition.

### EXAMPLE 31

Particle Production Example 4

Cedarwood essential oil (100 g) was added to 200 g diisodecyl adipate. Then the mixture was finely divided by a bead mill to give a suspension having a concentration of about 30 wt % in terms of solid content. The suspension was mixed with 25 g of SMIJULE L-75, and the mixture was added to 325 g of water containing 30 g of gum arabic and 20 g of ethylene glycol. The mixture was stirred at an ordinary temperature by T.K. autohomomixer to give fine droplets, which were stirred at 60° C. for 24 hours, thereby giving a slurry containing procymidone suspended in diisodecyl adipate and micro-encapsulated with a polyurethane film. Added to the slurry was 350 g of water containing 1 g of xanthane gum and 5 g of aluminum magnesium silicate, whereby 10 wt % of cedarwood essential oil capsule composition was obtained.

### EXAMPLE 32

Particle Production Example 5

Copaene (100 g) was added to a mixture of 150 g of phenylxylyl ethane and 50 g of diisodecyl adipate. Then the mixture was finely divided by a bead mill to give a suspension having a concentration of about 32 wt % in terms of solid content. Added to the suspension was 50 g of SMIJULE L-75. Then the mixture was added to 530 g of water containing 30 g of gum arabic and 30 g of ethylene glycol. The mixture was stirred at an ordinary temperature by T.K. autohomomixer to give fine droplets, which were stirred at 60° C. for 24 hours, thereby giving a slurry containing copaene suspended in a mixture of phenylxylyl ethane and diisodecyl adipate and micro-encapsulated with a polyurethane film. Added to the slurry was 120 g of water containing 1 g of xanthan gum and 5 g of aluminum magnesium silicate, whereby 10 wt % of a copaene composition was obtained.

### EXAMPLE 33

Particle Production Example 6

A mixture of 80 g of trans-α-bergamotene and 20 g of elemi oil was added to a mixture of 100 g of phenylxylyl ethane and 100 g of diisodecyl adipate. Then the mixture was finely divided by a bead mill to give a suspension having a concentration of about 30 wt % in terms of solid content. The suspension was mixed with 25 g of SMIJULE L-75, and the mixture was added to 500 g of water containing 15 g of polyvinyl alcohol and 20 g of ethylene glycol. The mixture was stirred at an ordinary temperature by T.K. autohomomixer to give fine droplets, which were stirred at 60° C. for 24 hours, giving a slurry containing procymidone suspended in a mixture of phenylxylyl ethane and diisodecyl adipate and micro-encapsulated with a polyurethane film. Added to the slurry was 175 g of water containing 1 g of xanthane gum and 5 g of aluminum magnesium silicate, whereby 10 wt % of trans-α-bergamotene and elemi oil capsule composition was obtained.

### EXAMPLE 34

Particle Production Example 7

A 5% aqueous solution (120 parts) of acrylic acid-acrylonitrile-2-acrylamide-2-methylpropaneslfonic acid copolymer was adjusted to a pH of 4.0 with a 10% aqueous solution of NaOH. 50 parts of garmacrene-D was added thereto and the mixture was emulsified with a homomixer. Added to the emulsion was 24 parts of an aqueous solution of methylated methylol melamine (80 wt % nonvolatile, product of Mitsui Toatsu Kagaku Co., Ltd. “Ulamine T-30”). The mixture was retained at 80° C. for 2 hours with stirring, giving a microcapsule dispersion containing microcapsules with an average particle size of 5.0 μm

### EXAMPLE 35

Particle Production Example 8

Mixed together were 63 parts of Delta-Cadinene (trade name), 8.11 parts of Araldite 6060 (trade name) as an epoxy resin, 0.97 part of Versamine K-11 (trade name) as ketimine and 0.20 parts of Accelerator 399 (trade name) The mixture was mixed with 130 parts of a 3% aqueous solution of Tamol L/Vinol 523 (trade names) (95:5) as an emulsifier to undergo emulsion. The obtained slurry was heated at 75° C. for 4 hours to give microcapsules.

The obtained product was found to contain spherical microcapsules under an electron microscope. An average particle size was about 5μ.

### EXAMPLE 36

Particle Production Example 9

Microcapsules were produced in the same manner as in Example 28 with the exception of using 6.87 parts of Araldite 3336 (trade name) as an epoxy resin, and 2.20 parts of Versamine K-11 (trade name) as ketimine. A number of tests were conducted in the same manner as in Example 21. It was found under an electron microscope that spherical microcapsules were formed and had an average particle size of 6μ.

### EXAMPLE 37

Particle Production Example 10

An aqueous solution of sodium hydroxide (20 g) was heated to 80° C. and 100 g of styrene maleic acid anhydride copolymer (trade name, Scripset 520, product of Monsant Co., Ltd.) was added. The mixture was stirred for 2 hours, giving 5 wt % of an aqueous solution of styrene maleic acid anhydride copolymer with a pH of 5.5.

In 150 g of the obtained solution was dispersed 200 g of a dispersion of silicone KF-96 suspended in 25 wt % of α-caryophyllene alcohol. Then hydrolyzate of styrene maleic acid anhydride copolymer was adsorbed around the suspension.

Melamine (9.9 g) was dispersed in the above-obtained solution and was stirred well. The above-mentioned solution was heated to 70° C. 25 wt % of glutaraldehyde was divided into 5 equal portions after which 25.7 g thereof was added in every 30 minutes. Methylolated melamine and styrene maleic acid copolymer was allowed to react with each other around the core material to cover the core material.

### EXAMPLE 38

Particle Production Example 11

An aqueous solution was prepared in the same manner as in Example 37.

Melamine (12.8 g) and 5.7 g of resorcin were dispersed and/or dissolved in the above-obtained solution and stirred well.

The above-obtained solution was heated to 70° C. and 25 wt % of glutaraldehyde was divided into 3 equal portions after which 27.2 g thereof was added in every 40 minutes. Around the core material, methylolated melamine, phenol resicin and styrene maleic acid copolymer were reacted to cover the core material.

### EXAMPLE 39

Particle Production Example 12

150 parts of a 3% aqueous solution of polyvinyl alcohol (trade name PVA-117, product of Clare Co. Ltd.) was placed in a stirring and mixing device equipped with a heater to provide an aqueous medium for producing capsules. Aside from the above, 5 parts of polymethylene polyphenyl isocyanate (trade name: Millionate MR 400, produced by Nippon Polyurethane Kogyo Co., Ltd.), and 2 parts of 2-isocyanato ethyl-2,6-diisocyanato hexaeate (trade name T-100, product of Toray Co., Ltd.) were dissolved in 100 parts of copaiba balsam. The obtained solution was dispersed as a capsule core material in the aqueous medium for producing capsules for 1 minute by a T.K. homomixer operated at 10000 r.p.m.

One part of diethylene triamine was added to the emulsion dispersion. Then the mixture was stirred at room temperature for 30 minutes. The temperature of the system was elevated to 70° C. A reaction was carried out for 3 hours with stirring. The temperature was reduced to room temperature, giving microcapsules having a resin wall film formed of polyurea resin/polyurethane resin with an average particle size of 5.7 μm, and an average film thickness of 0.16 μm.

### EXAMPLE 40

Particle Production Example 13

Use was made of oligomers, monomers, photopolymerization initiators, aromas (flavors), natural essential oils, UV absorbers, light stabilizers and dyes according to Table 6. The components shown in Table 6 are as follows.

TABLE 6

| | | Example | | | | | Comparative Example | | | |
|---|---|---|---|---|---|---|---|---|---|---|
| | | 1 | 2 | 3 | 4 | 5 | 1 | 2 | 3 | 4 |
| Oligomer | A | 40 | | | | | 40 | | | |
| | B | | 50 | | | | | 50 | | |
| | C | | | 40 | | 30 | | | 40 | |
| | D | | | | 50 | | | | | 50 |
| Monomer | E | | 30 | | 40 | | | 30 | | 40 |
| | F | 50 | | 40 | | | 50 | | 40 | |
| | G | | | | | 40 | | | | |
| Photopolymerization | H | 2 | | 3 | | | 2 | | 3 | |
| Initiator | I | | 3 | | 2 | | | 3 | | 2 |
| Aroma | J | 10 | | 20 | | 30 | 10 | | 20 | |
| | K | | 20 | | 10 | | | 20 | | 10 |
| UV absorber | L | 0.2 | | 0.1 | | 0.1 | | 0.01 | 3.0 | |
| | M | | 0.05 | | 0.1 | | | | | |
| Light stabilizer | N | | 0.05 | | 0.1 | | | | 3.0 | 0.005 |
| | O | 0.1 | | 0.1 | | 0.2 | | | | |
| Dye | P | 1 | | 1 | | 0.5 | 1 | | 1 | 1 |
| | Q | | 1 | | 1 | | | 1 | | |
| Property | Curability | A | A | A | A | A | A | A | C | A |
| | Hardness | 85 | 45 | 70 | 55 | 89 | 90 | 50 | — | 55 |
| | Fading A | A | A | A | A | A | C | B | — | B |
| | Fading B | A | A | A | A | A | C | C | — | C |

Oligomer A: Epoxyacrylate B: Polyester acrylate C: Urethane acrylate D: Alkyd poly acrylate Monomer E: 2-Ethylhexyl acrylate F: Diethylene glycol diacrylate G: Dipentaerythritol hexaacrylate Photopolymerization initiator H: Benzyldimethylketal I: 1-Hydroxycyclohexylphenyl ketone Aroma J: 2-Hydroxy-2-methylpropiophenone K: 2,2-Dimethoxy-2-phenyl acetophenone UV absorber L: 2,4-dihydroxybenzophenne M: 2-(2′-Hydroxy-5′-methyl phenyl)benzotriazole Light stabilizer N: 4-Hydroxy-2,2,6,6-tetramethyl piperidine O: di(2,2,6,6-Tetramethyl piperidine-4-yl)-sebasic acid ester Dye P: Anthraquinone-based dye (blue) (0.5% butanol solution) Q: Azo-based dye (red) (0.5% butanol solution).

The letters A, B, C in the table express the evaluation of the properties: A indicates that the property is excellent; B indicates that the property is fair; and C indicates that the property is poor.

The substances shown in Table 6 were fully mixed and disposed to a depth of 1 cm in a transparent glass container, 7 cm in diameter and 2 cm in depth. Light was irradiated by a pressure mercury lamp for curing them, giving colored repellent particles.

### EXAMPLE 41

Production of particle dispersion (A)

| | Wt % |
|---|---|
| 10 wt % of lemon essential oil | 15 |
| capsule composition of Particle | |
| Production Example 1 | |
| Sodium polyacrylate | 0.5 |
| Purified water | Proper amount |
| | 100 |

### EXAMPLE 42

Production of particle dispersion (B)

| | Wt % |
|---|---|
| 5 wt % of bergamot essential oil | 15 |
| capsule composition of Particle | |
| Production Example 2 | |
| Sodium alginate | 1 |
| Polyoxyethylene sorbitan monolaurate | 2 |
| Sodium metaphosphate | 2 |
| Purified water | Proper amount |
| | 100 |

The particle dispersion was prepared in the same manner as above using the above composition.

### EXAMPLE 43

Production of particle dispersion (C)

| | Wt % |
|---|---|
| 10 wt % of clove leaf essential oil | 15 |
| capsule composition of Particle | |
| Production Example 3 | |
| Methyl cellulose | 1 |
| Polyoxyethylene alkyl ether | 1 |
| Polyglycerin fatty acid ester | 1 |
| Potassium metaphosphate | 1 |
| Polyvinyl pyrrolidone | 3 |
| Purified water | Proper amount |
| | 100 |

The particle dispersion was prepared in the same manner as above using the above composition.

### EXAMPLE 44

Production of particle dispersion (D)

| | Wt % |
|---|---|
| 10 wt % of cedarwood essential oil | 20 |
| composition of Particle Production | |
| Example 4 | |
| Zinc pyrithione | 5 |
| Aromatic dialkyl carboxylic acid ester | 25 |
| Hydrophobic mica | 10 |
| Toluene | Proper amount |
| | 100 |

### EXAMPLE 45

Production of particle dispersion (E)

| | Wt % |
|---|---|
| 10 wt % of copaene capsule composition | 15 |
| of Particle Production Example 5 | |
| Lipophilic bentonite | 7 |
| Ethyl cellulose | 3 |
| Ethyl acetate | Proper amount |
| | 100 |

### EXAMPLE 46

Production of Repellent Active Adhesive

3 wt % of each of particle dispersions produced in Examples 41 to 45 was added to an acrylic resin-based adhesive containing a 50% aqueous emulsion solution of acrylic resin and natural rosin (pine resin) at a ratio of 95:5. The mixture was fully mixed, giving a sanitary insect pest repellent active adhesive.

### EXAMPLE 47

The same as above.

### EXAMPLE 48

The same as above.

### EXAMPLE 49

The same as above.

### EXAMPLE 50

Ink Production Example

A solution was prepared by adding 10 parts of dioctyl phosphate to 300 parts of toluene to give a mixed solution. One hundred parts (solid content) of microcapsules prepared in Production Example 7 was added. The water was removed by azeotropic dehydration.

Observation of this microcapsule solution under a microscope showed that microcapsule particles were individually dispersed without giving rise to cohesion.

Ten parts of MALKYD 32 (trade mark, maleic acid resin, product of Arakawa Chemical Industries Co., Ltd.) was dissolved in the microcapsule dispersion. To the solution was added 20 parts of cellulose powder, giving gravure ink.

### EXAMPLE 51

Production of aqueous repellent active flexo ink

| | Wt % |
|---|---|
| Pigment (red) | 20 |
| Acrylic resin (main ingredient) | 30 |
| Water | 49 |
| Diethanolamine | 1 |

5 wt % or 10 wt % of the particle dispersion (A) prepared in Example 41 was added to an aqueous flexo ink prepared by mixing the above-mentioned ingredients, giving a repellent active flexo ink.

### EXAMPLE 52

Production of repellent active flexo clear ink

| | Wt % |
|---|---|
| Acrylic resin (main ingredient) | 40 |
| Water | 60 |

5 wt % or 10 wt % of the particle dispersion (B) prepared in Example 42 was added to the aqueous flexo ink obtained by mixing the above-described ingredients, giving a repellent active flexo clear ink.

### EXAMPLE 53

Production of repellent active (against Indian meal moth) ink

| | Wt % |
|---|---|
| Pigment (blue) | 20 |
| Acrylic resin (main ingredient) | 20 |
| Ethylene glycol | 20 |
| Glycol | 20 |
| Amino alcohol | 5 |
| Ethyl alcohol | 12 |
| Auxiliaries | 3 |

5 wt % or 10 wt % of the particle dispersion (C) prepared in Example 43 was added to the printer sloetter ink prepared by mixing the above-mentioned ingredients, giving repellent active printer sloetter ink.

### EXAMPLE 54

Production of oily flexo ink

| | Wt % |
|---|---|
| Pigment | 20 |
| Polyamide-based resin | 15 |
| Toluene | 35 |
| Methyl ethyl ketone | 10 |
| Isopropyl alcohol | 20 |

5 wt % or 10 wt % of the particle dispersion (D) prepared in Example 44 was added to an oily flexo ink prepared by mixing the above-mentioned ingredients, giving a repellent active oily flexo ink.

### EXAMPLE 55

Production of UV ink for overprint

| | Wt % |
|---|---|
| Epoxy acrylate (oligomer) | 50 |
| 1,6-Hexanediol diacrylate | 8 |
| Trimethylol propane triacrylate | 30 |
| 2-Hydroxy-2-methylpropiophenone | 6 |
| 2,2-Dimethoxy-2-phenylacetophenone | 4 |
| Wax | 1 |
| Diethanolamine | 1 |

5 wt % or 10 wt % of the particle dispersion (E) prepared in Example 38 was added to a UV ink for overprint prepared by mixing the above-mentioned ingredients, giving a repellent active oily flexo ink.

### EXAMPLE 56

Production of Insect Repellent Polypropylene Pellets

Polypropylene resin pellets (product of Showa Denko Co., Ltd., SUNALLOMER PF621S) were filled at a filling rate of 12 kg/h along with 10 wt % of lemon essential oil capsule composition of Particle Production Example 1 at a filling rate of 3 kg/h with use of a double screw extruder at 200 to 220° C. at a filling ratio of polypropylene resin (80 wt %) and 10 wt % of lemon essential oil capsule composition of Particle Production Example 1 (20 wt %) and were kneaded together, giving insect repellent polypropylene resin pellets carrying 10% of 10 wt % of lemon essential oil capsule composition, measuring about 2 mm (diameter)×about 3 mm.

### EXAMPLE 57

Production of a Film Carrying 5% of 5 wt % of Bergamot Essential Oil Capsule Composition of Particle Production Example 2

50 wt % of polypropylene resin pellets (product of Showa Denko Co., Ltd., SUNALLOMER PF621S) and 50 wt % of insect repellent polypropylene resin pellets prepared in the same manner as in Example 29 were mixed by a stirrer. Using the obtained mixture of bergamot essential oil capsule-containing polypropylene resin pellets, an insect pest repellent polypropylene resin tube-shaped film of 20 μm in film thickness and 210 mm in width carrying 5% of 5 wt % of bergamot essential oil capsule composition of Production Example 2 with use of a water-cooling inflation extruder (product of Yamaguchi Mfg., YP50NC) at 205 to 220° C. for about 5 seconds at a drawing rate of 30 m/min.

### EXAMPLE 58

Production of a Film Carrying 2.5% of 10 wt % of Cedarwood Essential Oil Composition of Particle Production Example 4

Mixed together by a stirrer were 75 wt % of polypropylene resin pellets (product of Showa Denko Co., Ltd., SUNALLOMER PF621S) prepared in the same manner as in Example 22, and 25 wt % of insect repellent polypropylene resin pellets prepared in the same manner as in Example 23. Using the obtained mixture of insect repellent polypropylene resin pellets, there was obtained a tube-shaped film of an insect repellent polypropylene resin of 20 μm in film thickness and 210 mm in width carrying 2.5% of 10 wt % of cedarwood essential oil capsule composition of Particle Production Example 4 with use of a water-cooling inflation extruder (product of Yamaguchi Mfg., YP500NC) at 205 to 220° C. for about 5 seconds at a drawing rate of 30 m/min.

### EXAMPLE 59

Incorporation of Repellent Into Paper During Manufacture of Paper

Ten g of 25% capsule of α-caryophyllene alcohol of Particle Production Example 10 was dispersed in 500 ml of a 1% solution of polyvinyl alcohol. Paper fibers (mixed yarn of pulp and Manila hemp) measuring 20 cm×0.4 cm² were immersed in the dispersion so as to provide a coat in an amount of about 2 to about 3 g/m² based on the paper fibers. The paper fibers were dried and coated with a-caryophyllene alcohol capsule composition of Particle Production Example 10, giving ant repellent paper.

### EXAMPLE 60

Production of repellent active coating composition

| | Wt % |
|---|---|
| Vinyl acetate-ethylene-acrylic resin | 20 |
| (main component) | |
| Aomori hinoki oil | 30 |
| Water | 50 |

5 wt % or 10 wt % of α-caryophyllene alcohol capsule particles prepared in Particle Production Example 10 were added to the above-described components, whereby an insect repellent active coating composition was prepared.

### EXAMPLE 61

Production of Slowly Releasable Inorganic Porous Particles Carrying Caryophyllene Oxide

15 g of caryophyllene oxide was mixed with 50 ml of an aqueous solution (SM) of sodium silicate having 5 g of polyoxyethylene (n=9) higher alcohol-based nonionic surfactant (Leodol SC-90, product of Lion Co., Ltd.) dissolved therein. The solution was emulsified by use of a homogenizer which was operated for 3 minutes at a stirring speed of 10000 or more revolutions per minute to form an O/W type (oil-in-water type) emulsion. The emulsion was mixed with 100 ml of toluene having 5 g of sorbitan monooleate (Leodol SP-010C-90, product of Kao Corp.) dissolved therein. The mixture was emulsified by use of a homogenizer, which was operated for 5 minutes at a rotary speed of 10000 revolutions per minute to form an O/W/o type emulsion. This emulsion was poured into 3

moles/liter of an aqueous solution of ammonium sulfate being stirred, followed by continuous stirring for 1 hour, whereby silica having caryophyllene oxide enclosed was formed. After forming silica, the reaction mixture was filtered and was further filtered after addition of 20 ml of water. Further after adding 20 ml of ethanol and filtering the mixture, 30 g of inorganic porous particles having caryophyllene oxide supported thereon were obtained.

### EXAMPLE 62

Production of Slowly Releasable Inorganic Porous Particles Carrying a Repellent Active Compound by Allowing the Previously Produced Slowly Releasable Porous Particles to Carry Caryophyllene Oxide Thereon

100 g of inorganic porous particles (Godball Silica B-6C, product of Suzuki Yushi Kogyo Co., Ltd.) were set into a vacuum chamber after which a leak valve and an introducing valve were closed while an exhausting valve was opened to reduce the pressure inside of the vacuum chamber to 1.0×10⁻² torr. Then the exhaust valve was closed to finish the removal of air from the vacuum chamber and the introducing valve was opened. Caryophyllene oxide was introduced into the vacuum chamber due to a difference in the pressure since the tank containing 100 g of caryophyllene oxide had an atmospheric pressure. The pressure in the voids of Godball was reduced by the removal of air from the vacuum chamber so that the repellent active compound fed into the vacuum chamber was permeated into the voids of Godball. After the vacuum chamber was returned to the atmospheric pressure by opening the leak valve, an excessive solution of copaiba oil was separated by filtration or otherwise, giving 200 g of inorganic porous particles enclosing caryophyllene oxide.

### EXAMPLE 63

Production of Slowly Releasable Organic Porous Particles Carrying Clove Leaf Essential Oil

Copaiba oil was added in an amount of 0.2 part per part of cyclodextrin (trade name: Dexypearl K-100, product of Ensuiko Seito Co., Ltd.). Then 1 part of water was added and the mixture was stirred by a homogenizer for 30 minutes. Thereafter the mixture was dried by hot air at 60° C. for about 3 hours, and clove leaf essential oil was subsumed, giving cyclodextrin carrying an insect repellent active compound thereon.

### EXAMPLE 64

Production of particle dispersion (A)

| | Wt % |
|---|---|
| Godball silica particles | 15 |
| Sodium polyacrylate | 0.5 |
| Hinokitiol | 5 |
| Clove leaf essential oil | 15 |
| Calcium propionate | 3 |
| Purified water | Proper amount |
| | 100 |

15 g of clove leaf essential oil and 5 g of hinokitiol were mixed with 50 ml of an aqueous solution (SM) of sodium silicate having 5 g of polyoxyethylene (n=9) higher alcohol-based nonionic surfactant (Leocol SC-90, product of Lion Co., Ltd.) dissolved therein. The solution was emulsified by use of a homogenizer or the like, which was operated for 3 minutes at a stirring speed of 10000 or more revolutions per minute to form an O/W type (oil-in-water type) emulsion. The emulsion was mixed with 100 ml of toluene having 5 g of sorbitan monooleate (Leodol SP-010, product of Kao Corp.) dissolved therein. The mixture was emulsified by use of a homogenizer, which was operated for 5 minutes at a rotary speed of 10000 revolutions per minute to form an O/W/O type emulsion. The emulsion was poured into 3 mole/liter of an aqueous solution of ammonium sulfate being stirred, followed by continuous stirring for 1 hour, whereby silica having clove leaf essential oil enclosed was formed. After forming silica, the reaction mixture was filtered and was further filtered after addition of 20 ml of water. Further after addition of 20 ml of ethanol and filtering the mixture, 30 g of Godball silica particles having clove leaf essential oil supported thereon were produced.

Silica particles enclosing the compound were added to purified water having 0.5 g of sodium polyacrylate and 3.5 g of calcium propionate dissolved therein. The mixture was uniformly dispersed by a homogenizer or a propelling stirrer, giving 100 g of a dispersion.

### EXAMPLE 65

Production of particle dispersion (B)

| | Wt % |
|---|---|
| Godball B-6C | 20 |
| White-cedar oil extract | 3 |
| Cedarwood essential oil | 3 |
| Zinc pyrithione | 5 |
| Aromatic dialkyl carboxylic | 25 |
| acid ester | |
| Hydrophobic mica | 10 |
| Toluene | Proper amount |
| | 100 |

3 g of cedarwood essential oil, 3 g of white-cedar oil extract, and 5 g of zinc pyrithione were enclosed in the following way with 20 g of Godball B-6C. 3 g of cedarwood essential oil, 3 g of white-cedar oil extract, and 5 g of zinc pyrithione were mixed with 67 ml of an aqueous solution (SM) of sodium silicate having 5 g of polyoxyethylene (n=9) higher alcohol-based nonionic surfactant (Leocol SC-90, product of Lion Co., Ltd.) dissolved therein. The solution was emulsified by use of a homogenizer, which was operated for 3 minutes at a rotary speed of 10000 or more revolutions per minute to form an o/W type (oil-in-water type) emulsion. The emulsion was mixed with 100 ml of toluene having 5 g of sorbitan monooleate (Leodol SP-010, product of Kao Corp.) dissolved therein. The mixture was emulsified by use of a homogenizer, which was operated for 5 minutes at a rotary speed of 10000 revolutions per minute to form an O/W/o type emulsion. The emulsion was poured into 3 mole/liter of an aqueous solution of ammonium sulfate with stirring, followed by continuous stirring for 1 hour, whereby silica having cedarwood essential oil supported thereon was formed. After forming silica, the reaction mixture was filtered and was further filtered after addition of 20 ml of water. Further after addition of 20 ml of ethanol, the mixture was filtered, giving 56 g of inorganic porous particles carrying cedarwood essential oil thereon.

After adding 31 g of of B-6C having a compound supported on 34 g of toluene having 10 g of hydrophobic mica and 25 g of aromatic dialkyl carboxylic acid ester dispersed therein, the mixture was stirred by a homogenizer operated at a rotary speed of 5000 revolutions per minute for 30 minutes, giving 100 g of a dispersion.

### EXAMPLE 66

Production of particle dispersion (C)

| | Wt % |
|---|---|
| Godball B-25C | 15 |
| Carboxymethyl cellulose | 1 |
| Hinokitiol | 5 |
| Second fraction of copaiba oil | 10 |
| Calcium propionate | 3 |
| Purified water | Proper amount |
| | 100 |

Using the above-mentioned composition, the operation was carried out in the same manner as in Example 66. However, a pH was not adjusted.

### EXAMPLE 67

Production of particle dispersion (D)

| | Wt % |
|---|---|
| Godball E-16C | 15 |
| Carboxymethyl cellulose | 1 |
| Hinokitiol | 5 |
| Third fraction of copaiba oil | 10 |
| Caryophyllene oxide | 1 |
| Calcium propionate | 3 |
| Purified water | Proper amount |
| | 100 |

Using the above-mentioned composition, the operation was carried out in the same manner as in Example 66.

### EXAMPLE 68

Production of particle dispersion (E)

| | Wt % |
|---|---|
| Silysia 250 | 15 |
| Carboxymethyl cellulose | 1 |
| Hinokitiol | 5 |
| Bergamot essential oil | 10 |
| Caryophyllene oxide | 3 |
| Calcium propionate | 3 |
| Purified water | Proper amount |
| | 100 |

Using the above-mentioned composition, the operation was carried out in the same manner as in Example 66.

### EXAMPLE 69

Production of particle dispersion (F)

| | Wt % |
|---|---|
| Nipsil E220A | 15 |
| Carboxymethyl cellulose | 1 |
| Hinokitiol | 5 |
| Lemon essential oil | 10 |
| α-caryophyllene alcohol | 5 |
| Calcium propionate | 3 |
| Purified water | Proper amount |
| | 100 |

Using the above-mentioned composition, the operation was carried out in the same manner as in Example 66.

### EXAMPLE 70

The particle dispersion (B) prepared in Example 65 was added to the rubber-based adhesive in an amount of 3 wt % based on the adhesive and mixed well together, giving a sanitary insect pest repellent active adhesive.

### EXAMPLE 71

Each of the particle dispersions prepared in Examples 66 to 69 was added, in an amount of 3 wt % based on the adhesive, to an acrylic resin-based adhesive of 50% aqueous emulsion solution containing the insect repellent active adhesive acrylic resin and natural rosin (pine resin) at a ratio of 95:5 of the former to the latter.

### EXAMPLE 72

The same as above.

### EXAMPLE 73

The same as above.

### EXAMPLE 74

The same as above.

### EXAMPLE 75

Production of aqueous repellent active flexo ink

| | Wt % |
|---|---|
| Pigment (red) | 20 |
| Acrylic resin (main ingredient) | 30 |
| Water | 49 |
| Diethanolamine | 1 |

The above-mentioned ingredients were mixed together to give aqueous flexo ink. 5 wt % or 10 wt % of the particle dispersion (A) prepared in Example 64 was added to the flexo ink, giving a repellent active flexo ink.

### EXAMPLE 76

Production of aqueous repellent active flexo ink

| | Wt % |
|---|---|
| Acrylic resin (main ingredient) | 40 |
| Water | 60 |

5 wt % or 10 wt % of the particle dspersion (A) prepared in Example 64 was added to the aqueous flexo ink obtained by mixing the above-mentioned ingredients, giving a repellent active flexo clear ink.

### EXAMPLE 77

Production of printer sloetter ink

| | Wt % |
|---|---|
| Pigment | 20 |
| Acrylic resin (main ingredient) | 20 |
| Ethylene glycol | 20 |
| Glycol | 20 |
| Amino alcohol | 5 |
| Ethyl alcohol | 12 |
| Auxiliaries | 3 |

5 wt % or 10 wt % of the particle dispersion (A) prepared in Example 64 was added to the printer sloetter ink obtained by mixing the above-mentioned ingredients, giving a repellent active printer sloetter ink.

### EXAMPLE 78

Production of oily printer sloetter ink

| | Wt % |
|---|---|
| Pigment | 20 |
| Polyamide resin | 15 |
| Toluene | 35 |
| Methyl ethyl ketone | 10 |
| Isopropyl alcohol | 20 |

5 wt % or 10 wt % of the particle dispersion (A) prepared in Example 64 was added to the oily flexo ink obtained by mixing the above-mentioned ingredients, giving a repellent active oily flexo ink.

Test for Repelling Mites on Adhesive (Method of Hindering Intrusion)

In respect of the adhesive produced in Example 70, the following common test method: the mite repellency test by the intrusion hindering method was conducted.

1. Method and Materials

(1) A specimen cut out into a circular shape of 3.5 cm in diameter was placed on an internal bottom surface of a petri dish having an internal diameter of 3.5 cm and a height of 1 cm, as shown in FIG. 5. Practically in the center of the bottom surface was disposed 0.05 g of a bait for allurement of mites (1:1 mixture of powdery feed for rearing small animals MF [product of Orient Kobo Co., Ltd.] and dried yeast specified in Japanese pharmacopeia. [product of Asahi Beer Co., Ltd.]). A sheet of the bait was laid closely on the bottom surface.

(2) The petri dish described in (1) was disposed in the center of a petri dish made of glass and having an internal diameter of 8.5 cm and a height of 2 cm. A mite medium was disposed on a space between the petri dish (3.5 cm in internal diameter) and the other petri dish (8.5 cm in internal diameter), not on the entire surface but around the petri dish of 3.5 cm in internal diameter.

(3) With the test condition set as above, mites were left free on the medium in the petri dish of 8.5 cm in internal diameter. The dishes were placed into a thermostatic chamber at 25±5° C. in the total darkness.

(4) In 24 hours, there was counted the number of live mites coming onto the specimen in the petri dish of 3.5 cm in internal diameter. Thereby the effect was evaluated.

(5) When a control plot was taken as a blank (an untreated specimen is not useful insofar a specimen can originally achieve an insect pest repellency). If the specimen in a treated plot achieves 70% or higher repellency, the specimen is determined to be repellent).
Repellency ratio (%)=[(number of live insects moving in the control plot−number of live insects moving in the treated plot/number of live insects moving in the control plot]×100

In the test, the repellency ratio was calculated based on the mites coming onto the adhesive surface of the kraft tape as to the respective effects in the control (free of the repellent compound), immediately after production (T=0), 6 months thereafter (T=6), and 12 months thereafter (T12).

3. Results

The results are shown in Table 7.

TABLE 7
[Test Example 7] Mite repellency test on the adhesive
(method of preventing intrusion)
Number of mites coming onto each specimen in the kraft
tape and repellency ratio (%)

| | Intruding | | Repellency ratio |
|---|---|---|---|
| Specimen | mite | | (%) |
| Control plot | (1) | 1081 | — |
| | (2) | 1167 | |
| | (3) | 1130 | |
| | Total | 3378 | |
| T = 0 | (1) | 333 | 79.8 |
| | (2) | 177 | |
| | (3) | 172 | |
| | Total | 682 | |
| T = 6 months | (1) | 45 | 95.4 |
| | (2) | 56 | |
| | (3) | 53 | |
| | Total | 154 | |
| T = 12 months | (1) | 312 | 70.5 |
| | (2) | 354 | |
| | (3) | 330 | |
| | Total | 996 | |

Number of mites coming onto each specimen in kraft tape and the repellency ratio (%)
4. Consideration

In view of the highest repellency ratio achieved after 6 months, presumably the release of repellent active substance was gradually increased after commencement of use of kraft tape, followed by decreased release.

### Brief Description of the Drawings

FIG. 1 is a view for describing one embodiment of a device using the repellent of the invention.

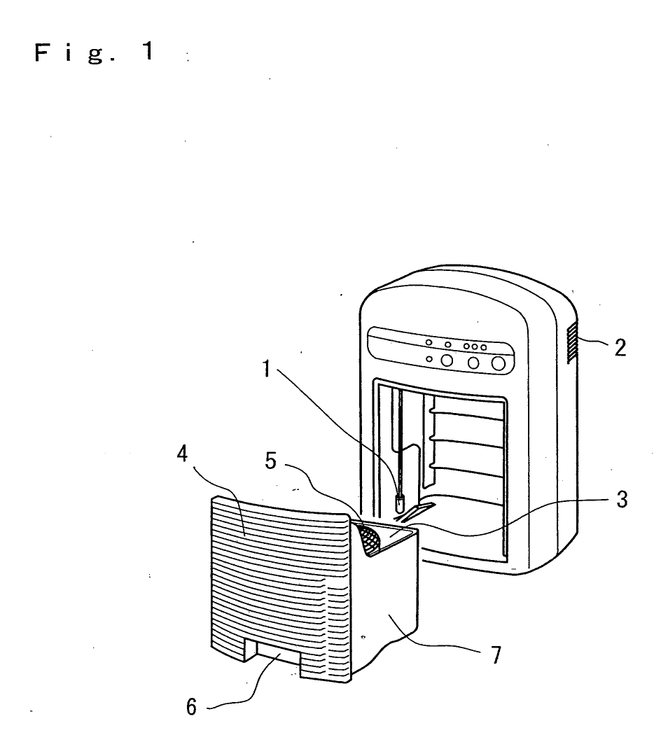

FIG. 2 is a perspective view and an sectional view of a petri dish to be used in the method of hindering mites' intrusion in the mite test.

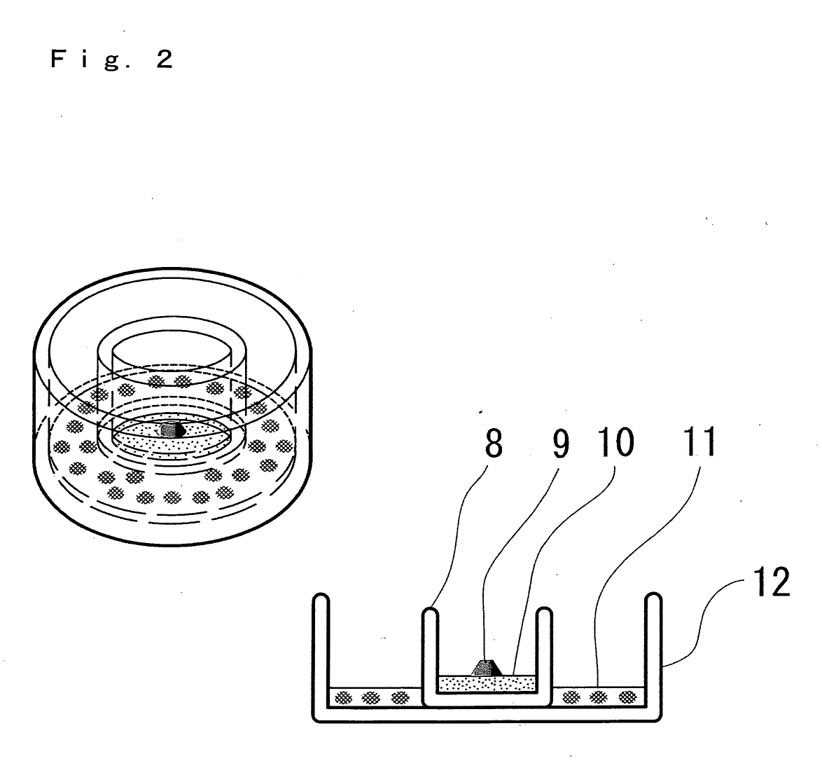

FIG. 3 is a view for describing the method of testing the cockroach repellency (Example 3).

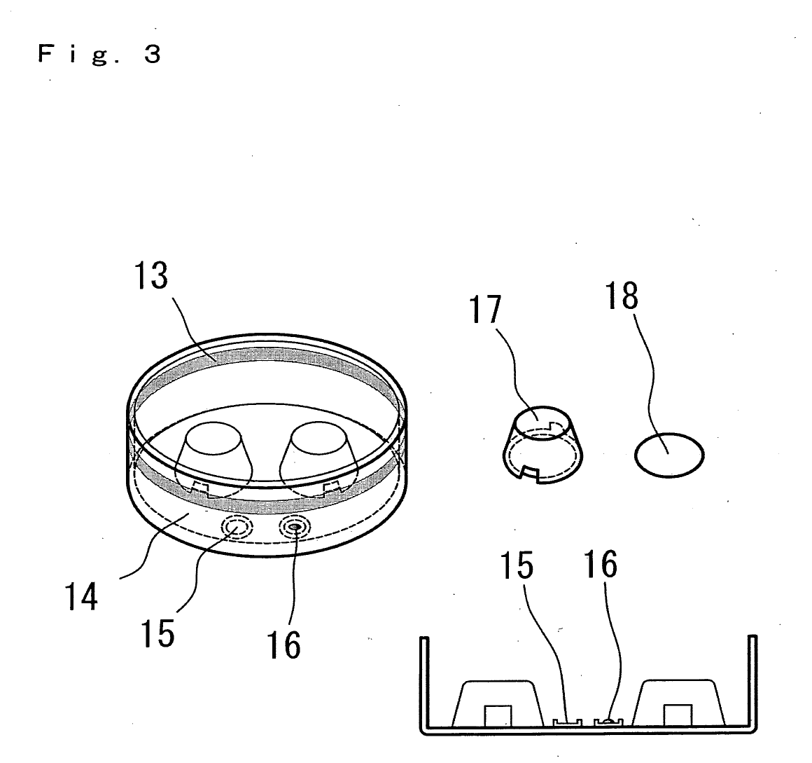

FIG. 4 includes (1) a plan view and (2) a sectional view showing the method of testing the repellency of a repellent film.

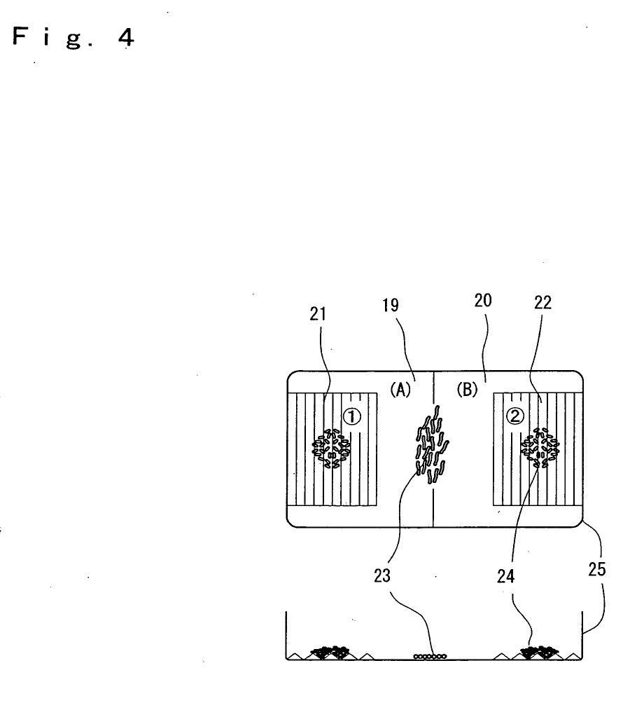

Description of reference characters: 1, terminal for detecting the water flow; 2, water inlet opening; 3, repellent; 4, exhaust opening; 5, vaporization opening; 6, hold for hand; 7, water tank; 8, 3.5 cm petri dish; 9, bait; 10, specimen; 11, test mite medium; 12, 8.5 cm petri dish; 13, vaseline; 14, glass container; 15, water; 16, bait; 17, aluminum dish; 18, specimen; 19, converted paper; 20, unconverted paper; 21, treated shelter; 22, untreated shelter; 23, test insect; 24, bait; 25, container.

1. A natural essential oil sanitary insect pest repellent containing, as an active component, at least one of copaiba oil, β-caryophyllene, a first fraction of copaiba oil given by silica gel column chromatography using hexane as an elution solvent, a second fraction given by silica gel chromatography using a 4:4:1 mixture of hexane/chloroform/ethyl acetate as an elution solvent, and a third fraction given by fractionating the remnant of the second fraction using a 1:1 mixture of ethyl acetate/chloroform as an elution solvent.

2. The natural essential oil sanitary insect pest repellent according to claim 1, wherein the first fraction is at least one of copaene and trans-α-bergamoten.

3. The natural essential oil sanitary insect pest repellent according to claim 1, wherein the second fraction is al least one of garmacrene-D, garmacrene-B and carylphyllene oxide.

4. The natural essential oil sanitary insect pest repellent according to claim 1, wherein the third fraction is α-caryophyllene alcohol.

5. A natural essential oil sanitary insect pest repellent, wherein at least one of natural essential oils of claim 1 is carried on organic high-molecular-weight particles.

6. The natural essential oil sanitary insect pest repellent according to claim 5 which contains a sedimentations inhibitor.

7. A natural essential oil sanitary insect pest repellent, wherein at least one of natural essential oils of claim 1 is carried on inorganic particles.

8. The natural essential oil sanitary insect pest repellent according to claim 7 which further contains a sedimentation inhibitor

9. A dispersion containing the natural essential oil sanitary insect pest repellent according to claim 1.

10. A sanitary insect pest repellent active adhesive or bond containing the natural essential oil sanitary insect pest repellent according claim 1.

11. A sanitary insect pest repellent active adhesive or bond containing the dispersion of the natural essential oil sanitary insect pest repellent according to claim 9.

12. An adhesive or bond product prepared using the adhesive of claim 10.

13. A sanitary insect pest repellent active ink containing the natural essential oil sanitary insect pest repellent according to claim 1.

14. A sanitary insect pest repellent active ink containing the dispersion of natural essential oil sanitary insect pest repellent dispersion according to claim 9.

15. A printed matter which is produced using the ink of claim 13.

16. A sanitary insect pest repellent active resin pellet containing the natural essential oil sanitary insect pest repellent according to claim 1.

17. A resin product containing, as the raw material, the resin pellets according to claim 16.

18. A sanitary insect pest repellent active sheet or film containing the natural essential oil sanitary insect pest repellent according to claim 1.

19. The sheet or the film according to claim 18 which is selected from the group consisting of paper, non-woven fabrics, natural fiber fabrics, chemical fiber fabrics and inorganic fiber fabrics.

20. A repellent device using the natural essential oil sanitary insect pest repellent according to claim 1.
